(19) United States
(12) Patent Application Publication
(10) Pub. No.: US 2026/0289498 A1
(43) Pub. Date: Sep. 24, 2026

(54) SYSTEM

(71) Applicant: SoftBank Group Corp., Tokyo (JP)

(72) Inventor: Rui FANG, Tokyo (JP)

(73) Assignee: SoftBank Group Corp., Tokyo (JP)

(21) Appl. No.: 19/567,311

(22) Filed: Mar. 16, 2026

(30) Foreign Application Priority Data
Mar. 19, 2025 (JP) 2025-045072

(51) Int. Cl. G06Q 10/087; G06F 40/284; G06N 3/0464; G06N 3/0475; H04L 51/02

(52) U.S. Cl. CPC G06Q 10/08726; G06F 40/284; G06N 3/0464; G06N 3/0475; H04L 51/02

(57) ABSTRACT

A system includes circuitry configured to receive image data from a terminal device via a packet-switched network, convert the image data into a normalized tensor representation, and process the representation through a convolutional neural network to detect items and generate structured item records including a category identifier, quantity estimate, and validity period. The circuitry receives user input and applies natural language processing to generate standardized preference data. A structured prompt combining the item records and preference data is provided to a generative neural network model to obtain procedure data including required items and operational steps. The circuitry identifies shortage items, generates and transmits order requests to an external transaction service, analyzes multimodal behavior data to estimate an affective state, and updates the procedure data or order requests based on the estimated affective state.

### CROSS-REFERENCE TO RELATED APPLICATION

This application is based on and claims priority under 35 USC 119 from Japanese Patent Application No. 2025-045072 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional cooking support systems and recipe recommendation services typically require users to manually input available ingredients, meal preferences, and shopping needs. Such manual input is time-consuming, error-prone, and difficult to maintain in real time as the contents of a storage device such as a refrigerator change. In addition, known systems seldom integrate automated ingredient recognition from images, automatic ordering of missing ingredients through an electronic commerce platform, and dynamic adjustment of cooking procedures based on the user's emotional state. As a result, users cannot efficiently receive cooking procedures that (i) accurately reflect the current contents of the storage device, (ii) satisfy their meal preferences, (iii) automatically procure lacking ingredients in a timely manner, and (iv) flexibly adapt the difficulty level, cooking time, or ingredient selection according to their emotional condition during cooking. Therefore, there is a need for a system that automatically acquires and analyzes images of a storage device, generates and presents customized cooking procedures by using generative AI models, orders missing ingredients, and adjusts the overall cooking experience in response to the user's emotional state.

### SUMMARY

In order to solve the above-described problems, a system according to one embodiment comprises a processor configured to control a camera of a user's mobile terminal to acquire an image of a storage device and to store the image as digital data. The processor is further configured to analyze the acquired image data by using a machine learning model to identify food items within the storage device and to specify a name, a quantity, and an expiration date of each of the food items. The processor is configured to acquire a meal preference of the user based on at least one of a voice input, a text input, and a selection input from the user, and to convert the meal preference into standardized data by using natural language processing. The processor is configured to provide, to a generative AI model, a prompt for instructing the generative AI model to generate cooking procedures, the prompt including the identified food information and the standardized meal preference data as input, and to generate cooking procedures based on the prompt by using the generative AI model. The processor is configured to analyze the generated cooking procedures, to compare the generated cooking procedures with the food items within the storage device, to identify lacking ingredients, to cooperate with an application programming interface of an electronic commerce platform to order the lacking ingredients, and to set a delivery time. Furthermore, the processor is configured, for each step of the generated cooking procedures, to provide, to the generative AI model, a prompt for instructing the generative AI model to generate an explanatory text of the cooking procedures, and to generate explanatory text to be presented visually or aurally to the user. The processor is also configured to acquire at least one of voice tone data, facial expression data, and body motion data of the user, to estimate an emotion of the user from the acquired data by using a machine learning model, and to provide, to the generative AI model, a prompt for instructing the generative AI model to determine an adjustment based on the estimated emotion, thereby determining adjustment content for at least one of contents of the cooking procedures, selection of ingredients, cooking difficulty level, cooking time, and contents of ingredient ordering.

The term “processor” refers to one or more hardware computation units, such as a central processing unit (CPU), a graphics processing unit (GPU), or a specialized accelerator, and may further include associated memory and control circuitry configured to execute program instructions for implementing functions of the present invention.

The term “mobile terminal” refers to a portable electronic device operated by a user, such as a smartphone, tablet, or mobile information terminal, that includes at least a display, an input interface, a communication interface, and optionally a built-in camera or imaging device.

The term “camera” refers to an image capturing device, including but not limited to an integrated camera module of a mobile terminal, that converts an optical image into digital image data suitable for processing by the processor.

The term “storage device” refers to a physical container or apparatus in which food items are stored, such as a refrigerator, freezer, pantry, or cabinet, including any compartment, shelf, or drawer thereof.

The term “image data” refers to digital data representing a still image or frame, typically encoded in a format such as JPEG, PNG, or a raw image format, and including pixel information suitable for analysis by an image processing or machine learning model.

The term “food item” refers to any edible product or ingredient stored within the storage device, including raw ingredients, processed foods, beverages, condiments, and packaged foods.

The term “machine learning model” refers to a computational model trained on data to automatically perform a task such as image recognition, classification, regression, or emotion estimation, including models based on neural networks, support vector machines, decision trees, or other learning algorithms.

The term “expiration date” refers to information indicating a recommended or required consumption deadline for a food item, including a best-before date, use-by date, or any similar indication of freshness or safety.

The term “meal preference” refers to information indicating a user's desired characteristics of a meal, such as preferred cuisine type, ingredients, cooking style, dietary restrictions, taste preferences, or desired portion size.

The term “natural language processing” refers to a set of computational techniques for analyzing and processing human language input, including recognition, parsing, classification, and semantic interpretation, so as to convert unstructured textual or spoken input into structured or standardized data.

The term “standardized data” refers to data that has been converted from a free-form or natural language format into a structured representation with predefined fields, categories, or codes suitable for further processing by the system.

The term “generative AI model” refers to a machine learning model configured to generate content, such as text describing cooking procedures or explanatory sentences, in response to input data or prompts, including but not limited to large language models and other sequence generation models.

The term “prompt” refers to information, which may include text, structured data, or a combination thereof, provided as input to a generative AI model in order to instruct the model to generate specific output content corresponding to a requested task.

The term “cooking procedures” refers to a sequence of actions, operations, or steps for preparing a meal or dish, including ingredient preparation, mixing, heating, seasoning, plating, and serving instructions.

The term “explanatory text” refers to natural language text generated for presentation to the user, describing or explaining the cooking procedures, operations, timing, or other guidance in a form understandable by the user.

The term “electronic commerce platform” refers to an online service or system that enables ordering, purchasing, and delivery of goods, including food ingredients, through a network, typically via an application programming interface.

The term “application programming interface (API)” refers to a defined interface, including a set of rules, protocols, and endpoints, that enables communication and data exchange between the system and an external service, such as an electronic commerce platform.

The term “voice tone data” refers to acoustic information derived from the user's speech, including features such as pitch, volume, tempo, and intonation, which can be used to infer emotional state.

The term “facial expression data” refers to information extracted from images or video of the user's face, including positions or movements of facial landmarks, which can be analyzed to estimate emotional state.

The term “body motion data” refers to information describing the movement or posture of the user's body, obtained for example from camera images, motion sensors, or wearable devices, and used to infer the user's emotional or physical state.

The term “emotion” refers to an internal state of the user, such as happiness, frustration, stress, calmness, or boredom, estimated from at least one of voice tone data, facial expression data, and body motion data by a machine learning model.

The term “adjustment content” refers to modifications determined by the system for at least one of the contents of the cooking procedures, selection of ingredients, cooking difficulty level, cooking time, and contents of ingredient ordering, based on the estimated emotion of the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like.

The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

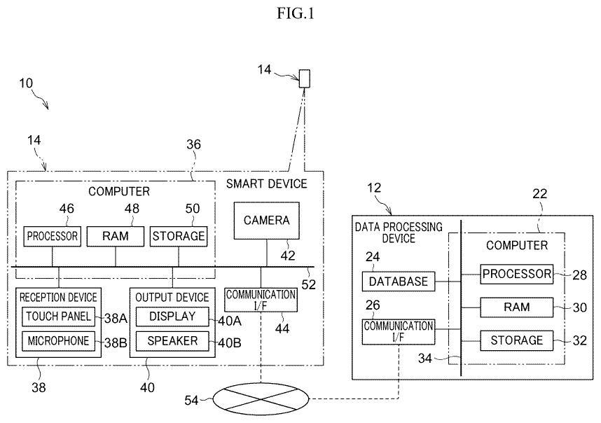

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

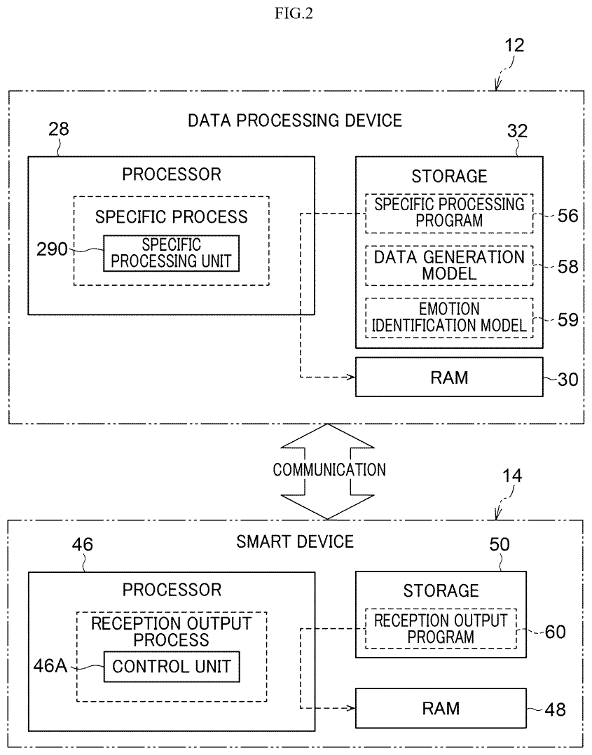

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional cooking assistance systems that propose recipes based on stored ingredients typically rely on static rule sets or simple matching between manually entered ingredient lists and predefined recipes. Such systems require the user to input inventory information by hand, to browse lengthy recipe lists, and to separately access commerce services for purchasing missing ingredients. As a result, the overall human-computer interaction is fragmented and inefficient. The computational resources of the underlying devices are consumed by multiple disconnected applications and services that do not share a unified data representation, which leads to redundant processing, inconsistent state management, and increased latency in providing actionable cooking guidance to the user.

Furthermore, existing systems do not fully exploit generative artificial intelligence models in a coordinated manner across the entire pipeline from perception of the storage environment, through interpretation of user preferences, to generation of structured cooking workflows and automatic ordering of missing items. In particular, generic use of generative models with ad hoc prompt sentences often yields unstructured or unpredictable outputs that are difficult for a computer to parse and integrate into downstream processes, such as progress tracking and real-time adjustment of instructions. This limits the ability of the system to perform automated control of user interfaces, inventory-based decision making, and commerce workflows in a reliable and scalable manner.

In addition, traditional systems provide limited adaptability to the dynamic physical and emotional state of the user. While some applications may display static step-by-step instructions, they generally do not acquire multimodal behavior data such as voice signals, facial images, and body motion signals, nor do they apply machine learning models to infer an emotional state that can be used to automatically adjust cooking difficulty, timing, or ingredient selection. As a consequence, computing resources are not leveraged to generate personalized and context-aware workflows, and the user is required to manually adjust or abandon proposed procedures when they feel tired, stressed, or rushed.

Therefore, there is a need for an improved computer-implemented technique that tightly integrates image recognition, natural language processing, and generative artificial intelligence through structured prompt sentences, in order to create machine-parseable cooking procedure data, to automatically order missing ingredients via an integrated commerce interface, and to dynamically adjust the generated procedures and ordering operations based on inferred user emotions. Such a technique should improve the internal operation of the server and the portable information terminal by reducing redundant processing, enforcing structured data formats, and enabling automated workflow control across perception, reasoning, and action stages.

The specific processing by the specific processing unit 290 of the data processing device 12 in Example 1 is realized by the following means.

The present invention provides a server comprising a processor configured to receive, from a portable information terminal, image data of a storage apparatus interior and preference data of a user, to execute image preprocessing and object recognition by using a machine learning model to generate item list data, to execute natural language processing on the preference data to generate standardized preference data, and to automatically construct structured prompt sentences for a generative artificial intelligence model based on the item list data and the standardized preference data, the processor being further configured to provide the structured prompt sentences to the generative artificial intelligence model to obtain structured cooking procedure data including step information, to compare ingredient requirements in the cooking procedure data with the item list data to identify insufficient ingredients, to generate and transmit commerce order data for the insufficient ingredients to an electronic commerce platform, to generate additional prompt sentences for the generative artificial intelligence model for generating presentation description data for each step, to transmit the presentation description data to the portable information terminal for stepwise user interface control, to receive multimodal behavior data representing at least one of a user voice signal, a user facial image, and a user body motion signal, to estimate an emotional state of the user by applying a machine learning model to the behavior data, and to construct and provide emotion-based adjustment prompt sentences to the generative artificial intelligence model to obtain adjustment result data for updating at least one of the cooking procedure data and the commerce order data. This enables an improvement of computer technology in that the server and the portable information terminal operate on unified, machine-parseable data structures generated by controlled prompt sentences, reduce redundant user input and manual workflow coordination, automatically integrate perception, reasoning, and commerce ordering within a single computational pipeline, and dynamically adapt system behavior and resource usage to the inferred emotional state of the user, thereby providing more efficient, reliable, and personalized cooking assistance.

The term “portable information terminal” refers to an electronic device that is portable and includes at least a display, an input interface, a communication interface, and a processing unit, such as a smartphone, tablet computer, or similar handheld computing device.

The term “imaging unit” refers to hardware and associated control software capable of capturing still images or moving images of a physical scene, such as a digital camera module including an image sensor, lens, and driver circuit, integrated into a portable information terminal.

The term “storage apparatus” refers to a container or equipment for storing goods, including but not limited to a refrigerator, freezer, pantry, cabinet, or other storage space used to hold food items or related articles.

The term “server” refers to one or more computing devices, including processors, memory, storage, and communication interfaces, configured to provide data processing, model execution, and network-based services to one or more client devices such as portable information terminals.

The term “image data” refers to digital data representing a captured image or sequence of images of a physical scene, encoded in any suitable format such as bitmap data or compressed data and suitable for processing by an image processing program or a machine learning model.

The term “communication network” refers to any wired or wireless network infrastructure that enables data transmission between devices, including public networks, local area networks, wide area networks, or combinations thereof.

The term “image processing program” refers to software executed by a processor to perform operations on image data, such as decoding, resizing, normalization, filtering, or feature extraction, prior to or in conjunction with machine learning-based analysis.

The term “machine learning model” refers to a computational model trained on data to perform tasks such as classification, detection, recognition, or regression, including but not limited to neural networks, decision trees, support vector machines, and other statistical models.

The term “object recognition processing” refers to processing that identifies one or more objects in image data, including determining an object category and optionally location or quantity, by applying a machine learning model or similar algorithm.

The term “item list data” refers to structured data representing a set of articles detected in a storage apparatus, including at least information indicating a category or type of each article and, optionally, quantity, location, or other attributes.

The term “abstract category information” refers to generalized or normalized data that expresses a type or class of an article, rather than a specific product instance, such as a food category name or ingredient type.

The term “preference information” refers to user-provided information that expresses a user's wishes or constraints regarding meals or cooking, including meal type, cuisine, number of persons, time constraints, or dietary preferences.

The term “standardized preference data” refers to structured data derived from preference information by natural language processing or rule-based processing, in which the data is normalized into predefined fields that a computer can systematically process.

The term “natural language processing” refers to a class of computational techniques for analyzing and transforming human language text or speech into a machine-usable representation, including tokenization, parsing, intent classification, and entity extraction.

The term “generative artificial intelligence model” refers to a machine learning model configured to generate content such as text, images, or structured data in response to input, including but not limited to large language models, sequence-to-sequence models, and transformer-based models.

The term “prompt sentence” refers to a text or text-like input provided to a generative artificial intelligence model that specifies context, instructions, constraints, or desired output format, and that guides the generative behavior of the model.

The term “cooking procedure data” refers to structured or semi-structured data representing at least one recipe and a sequence of steps for preparing a meal, including information such as step order, operations to perform, required ingredients, and optional timing.

The term “recipe information” refers to data describing a particular dish, including at least a dish name and an associated set of ingredients and cooking steps.

The term “step information” refers to data describing an individual step in a procedure, including content of the action to be taken, a sequence order, and optionally timing or required tools or ingredients.

The term “ingredient requirement information” refers to data indicating which ingredients, and in what quantities or units, are needed to perform a cooking procedure as specified in cooking procedure data.

The term “candidate insufficient ingredients” refers to ingredients determined, by comparison between ingredient requirement information and item list data, to be missing or insufficient in the storage apparatus for completing a proposed cooking procedure.

The term “product category information” refers to data that associates an ingredient or item with a classification used by a commerce system, such as a product group, category code, or generic label suitable for ordering.

The term “application programming interface” refers to a defined interface exposed by a software service or platform, through which external systems can programmatically send requests and receive responses, typically using a standardized protocol.

The term “electronic commerce platform” refers to a hardware and software system that provides catalog, ordering, payment, and logistics services for products offered over a communication network, including but not limited to online retail or grocery delivery services.

The term “order data” refers to structured data transmitted to an electronic commerce platform that specifies items to be purchased, quantities, delivery destination, delivery time, and optionally payment or user information.

The term “delivery destination information” refers to data specifying a physical location to which ordered goods are to be delivered, such as an address or delivery point identifier.

The term “desired delivery time information” refers to data specifying a requested delivery time or time window for ordered goods, used by a commerce platform to schedule logistics operations.

The term “step structure data” refers to structured data extracted from cooking procedure data for each step, including at least a description of the step, a required time, and identification of ingredients used in that step.

The term “presentation prompt sentence” refers to a prompt sentence provided to a generative artificial intelligence model that instructs the model to generate explanation or guidance content suitable for visual or auditory presentation to a user for a particular step.

The term “description data” refers to text or audio script content generated by a generative artificial intelligence model based on a presentation prompt sentence, intended to describe a step or procedure in a user-understandable manner.

The term “user interface” refers to a combination of hardware and software elements that allow a user to interact with a device or application, including displays, touchscreens, speakers, microphones, and graphical or voice-based interaction components.

The term “progress status data” refers to data indicating a current state or advancement of a multi-step procedure, such as which step has been completed, which step is active, and optionally timestamps or user feedback.

The term “external sensor” refers to a sensing device separate from the basic input components of a portable information terminal, capable of acquiring physical measurements related to a user or environment, such as cameras, microphones, or motion sensors.

The term “behavior data” refers to data representing observable characteristics of a user's behavior, including voice signals, facial images, and body motion signals, acquired by at least one of a portable information terminal and an external sensor.

The term “emotional state” refers to a representation of a user's inferred affective condition, such as calmness, stress, fatigue, or enthusiasm, estimated by applying a machine learning model to behavior data.

The term “adjustment prompt sentence” refers to a prompt sentence provided to a generative artificial intelligence model that instructs the model to propose modifications to at least one of cooking procedures, ingredient selections, cooking difficulty, cooking time, or ordering contents based on contextual information including an emotional state.

The term “adjustment result data” refers to data generated by a generative artificial intelligence model in response to an adjustment prompt sentence, specifying changes to be made to cooking procedure data and/or order data.

The term “presentation description data” refers to description data specifically formatted or structured for use in presenting guidance to a user stepwise, including information suitable for display or audio output at each step.

The term “interactive presentation data” refers to structured data that defines how presentation description data and associated user interface elements should be displayed or controlled, including mappings between steps, input elements, and notification timing information.

The term “past cooking history data” refers to stored data regarding previous cooking sessions or recipes used by the user, including at least identifiers of recipes, timestamps, and optionally ratings, modifications, or completion status.

The term “product inventory information” refers to data indicating availability, stock levels, or similar inventory status of items in an electronic commerce platform's catalog.

The term “deliverable time information” refers to data indicating available delivery slots or times during which a commerce platform can deliver ordered goods to a specified destination.

In one embodiment, a server, a terminal, and a user cooperate to implement the claimed system. The server is realized as one or more computing machines, for example a rack-mounted server running a general-purpose operating system such as a Unix-like system, equipped with at least one central processing unit, volatile and non-volatile memory, and optionally a graphics processing unit supporting parallel numerical computation. The terminal is realized as a portable information device, such as a handheld communication device, that includes an imaging unit, a display, an input interface, a wireless communication module, and a local processor. The user interacts with the terminal through a graphical user interface and through voice and body movements.

The terminal executes an application program that includes modules for camera control, user preference input, communication with the server, and presentation of cooking instructions. The terminal activates the imaging unit via an operating system camera application programming interface and acquires image frames of the interior of a storage apparatus such as a refrigerator.

The terminal encodes the captured data into an image data format such as a compressed still-image format, stores the encoded data in a local storage device, and then transmits the stored image data to the server over a packet-based communication network via a secure protocol.

The server executes a program that includes an image processing module, an item recognition module, a natural language processing module, a prompt generation module, a generative AI model interface module, an ordering module, a behavior analysis module, and a stepwise presentation management module. The server loads image data received from the terminal into system memory and applies an image processing program, such as an image library implementing resizing, color space conversion, and normalization. The server converts the pixel values to floating point tensors of a fixed size suitable for input to a trained convolutional neural network. The server uses the item recognition module, which incorporates a machine learning model such as a deep convolutional network with multiple convolutional layers, pooling layers, and fully connected layers, trained on images of food items and storage environments, to compute feature maps and classification outputs.

The server uses these feature maps to perform object recognition processing. The server interprets the output of the final classification layer, which provides probability scores over predefined ingredient categories, and optionally bounding box regression outputs for localization. The server filters the outputs according to a confidence threshold and aggregates detections belonging to the same category to estimate quantities. The server generates item list data as a structured data object that includes, for each detected category, a normalized category identifier and a quantity estimate. The server stores the item list data in a storage subsystem such as a relational database system, indexed by user identifier and acquisition time, thereby enabling later retrieval and cross-session tracking.

The user inputs preference information via the terminal. The user enters text such as “I want to eat Japanese food tonight” or selects values from menus such as “Cuisine: Japanese,” “Number of persons: 2,” and “Cooking time: within 30 minutes.” The terminal converts this input to a textual representation and transmits the representation to the server. The server uses the natural language processing module to perform tokenization, part-of-speech tagging, named entity recognition, and intent classification. The server uses a sequence model, such as a recurrent neural network or transformer-based encoder trained on cooking-related text, to map the free-form text to predefined preference slots. The server thereby generates standardized preference data that specifies a meal type, serving count, time constraints, dietary restrictions, and user taste preferences in a compact, machine-readable form.

The server combines the item list data and the standardized preference data within the prompt generation module. The server constructs a prompt sentence for a generative AI model in a structured manner that includes explicit sections: a listing of available ingredients mapped to abstract categories, a normalized description of user preferences, and explicit formatting instructions for the desired output. For example, the server generates a prompt sentence such as: “Available ingredients in the refrigerator: salmon, tofu, eggs, carrots. The user wants to eat Japanese food tonight for two people and prefers simple dishes that can be prepared within 30 minutes. Propose one or more Japanese recipes that maximize the use of these ingredients. For each recipe, output the title, list of ingredients with quantities, and detailed step-by-step cooking instructions with estimated time for each step. Also list any missing ingredients that must be purchased.”

The server interfaces this prompt sentence and auxiliary structured context to a generative AI model. In one embodiment, the generative AI model is a transformer-based language model with multiple self-attention layers, feedforward layers, and residual connections, trained on large-scale cooking and general text data. The server represents the prompt sentence as a sequence of token identifiers using a subword tokenizer and feeds this sequence through the model. The server configures the model inference with parameters such as maximum output length, sampling temperature, and repetition penalties, so as to balance creativity with determinism and maintain a machine-parseable structure.

The server parses the output text of the generative AI model according to markings or key phrases included in the prompt. For example, the server expects structured sections such as “Recipe 1:”, “Ingredients:”, “Steps: 1., 2., 3.” and “Missing ingredients:”. The server uses simple parsing rules, regular expressions, and, in some embodiments, an auxiliary classifier, to convert the output text into cooking procedure data, including recipe information and step information. The cooking procedure data is stored in a structured internal representation: a collection of recipe objects, each containing an ordered sequence of step objects that reference ingredient identifiers and contain estimated times and textual descriptions.

The server uses this internal structured representation to perform operations that differ from a simple human-like reading of text. For example, the server compares the ingredient requirement information of the generated recipes against the stored item list data using normalized category identifiers and quantity fields. The server determines candidate insufficient ingredients by computing set differences and numeric deficits. The server maps these candidate insufficient ingredients to product category information used by an external commerce platform, using a mapping table or learned embedding that relates abstract food categories to commercial product codes.

The server then activates the ordering module. The server creates order data including product category identifiers, quantities, user delivery destination information, and desired delivery time information. The server obtains deliverable time information and product inventory information from the commerce platform through its application programming interface. The server may query available delivery slots and stock levels and select an appropriate slot that aligns with a stored or newly entered user return-home time. By forming the order data and transmitting it via a defined application programming interface, the server effects a control of external logistics systems that would not be easily achievable by a user without computational assistance.

The server also leverages generative AI models for user-facing presentation. For each step in the cooking procedure data, the server extracts step structure data: the underlying operation, its required time, and the involved ingredients. The server constructs a presentation prompt sentence such as:

“Explain the following cooking step in simple language suitable for a non-expert cook. Step: ‘Sprinkle salt on the salmon fillets and let them rest for 10 minutes.’ Include a brief explanation of why this step is important, and keep the explanation within three sentences.”

The server feeds this prompt sentence to the generative AI model and obtains description data, which consists of explanatory text adapted to human understanding. The server converts this description data into presentation description data that can be displayed or spoken on the terminal, including flags for text-to-speech conversion if audio output is desired.

The terminal receives the presentation description data and displays it step by step on its display. The terminal renders buttons for step navigation and transmits progress status data such as “current step index” and timestamps back to the server. The server can thus maintain synchronized state about which step the user is currently performing, which enables the server to align notifications, delivery timing, and adjustments of future steps.

The server collects behavior data representing the user's voice signals, facial images, and body motion signals. The terminal or external sensors capture these data streams, for example via the terminal microphone, front-facing camera, or an external motion sensor device, and send them to the server after appropriate encoding and compression. The server applies a behavior analysis model, which may include a convolutional network for image-based facial expression analysis, a recurrent network or transformer for audio-based prosody analysis, and a temporal model for body motion signals. The server fuses the outputs of these models to estimate an emotional state vector representing affective dimensions such as stress level, fatigue, and engagement.

The server utilizes this emotional state within a second stage of prompt generation. The server constructs an adjustment prompt sentence that instructs the generative AI model to modify existing cooking procedures or ordering decisions. For example, the server can generate a prompt such as:

“The current cooking plan includes: Recipe ‘Grilled Salmon’ and Recipe ‘Tofu Miso Soup’ with the following steps: [summary of steps]. The user appears tired and has limited attention. Propose adjusted cooking procedures that reduce overall cooking time and simplify the steps, while still using the available ingredients: salmon and tofu. Indicate any steps that can be skipped or merged, and update the required ingredients accordingly.”

The server feeds this adjustment prompt sentence, along with the structured cooking procedure data and emotional state parameters, to the generative AI model. The server receives adjustment result data and merges it into the existing structured representation. The server may delete, reorder, or annotate steps based on the adjustments, and may also update the order data by canceling or modifying orders for ingredients that are no longer needed due to simplification.

In this way, the server does not merely automate human reasoning but implements an internal pipeline that converts unstructured sensor data and user language into machine-optimized data structures and then uses those structures to control both user interface and external commerce systems. The server encapsulates non-conventional data flows in which image recognition outputs, natural language preferences, and emotional estimates are jointly encoded into structured prompt sentences that drive the generative AI model to produce outputs with predictable structure. This structure allows efficient parsing and downstream computation and is distinct from simple human consumption of free-form AI-generated recipes.

From the standpoint of computer technology, the described architecture yields several technical effects. The server reduces redundant computation by reusing a single item list data representation for both recipe generation and ordering decisions, rather than recomputing or re-entering ingredient information in separate subsystems. The server improves processing speed and scalability by delegating intensive numerical operations such as convolution, self-attention, and gradient-based training during a pre-deployment phase to specialized processors like graphics processing units and by using fixed-size tensor shapes and batched operations. The server improves accuracy of ingredient detection by employing a learned convolutional network and by applying data augmentation techniques during training, such as random cropping, brightness variation, and horizontal flipping, which enable robust recognition under varied refrigerator conditions.

The server also enhances data management by maintaining normalized identifiers for ingredients, products, and user preferences across different modules. This normalization reduces inconsistencies and avoids ambiguous mappings that would arise in naive text-based systems.

The generative AI model is configured to output recipe and step information with explicit markers and templates, as constrained by the prompt sentences, which lowers parsing error rates and reduces the need for heuristic post-processing. As a result, the overall system performs fewer retries and fewer network calls, thereby reducing communication load and response latency.

The training of the machine learning models is carried out prior to deployment. The server, or an associated training environment, uses supervised learning on annotated datasets of refrigerator images, recipe texts, and multimodal emotional cues. The server minimizes a composite loss function that includes cross-entropy for ingredient classification, localization loss for bounding boxes if used, sequence loss for language modeling, and classification loss for emotion labeling. During training, the learning algorithm updates model parameters via gradient descent-based methods using mini-batches of data, and performs regularization such as dropout, weight decay, and early stopping. By tuning hyperparameters such as learning rate, batch size, and network depth, the server developers obtain models that meet target inference times and accuracy thresholds suitable for interactive cooking assistance.

Alternative embodiments can use different model architectures. In some embodiments, the item recognition module uses a single-stage detection network that simultaneously predicts object classes and locations, while in other embodiments a two-stage detection network is used. In some embodiments, the generative AI model is deployed on the server hardware, while in other embodiments the server calls a remote model service through a dedicated interface. In some embodiments, part of the natural language processing or presentation logic may run locally on the terminal to further reduce communication load and response time.

Alternative configurations of the prompt generation module are also possible. The server can adapt prompt sentences based on historical usage patterns stored in past cooking history data, such as “The user often prefers grilled dishes and light seasoning,” and include such information in the prompt to tailor outputs. The server can also vary the level of detail requested from the generative AI model, for example instructing it to output only high-level steps when the user's emotional state indicates fatigue, thereby saving display space and cognitive load.

The described system thus provides a concrete implementation of coordinated image processing, natural language processing, and generative AI control that is tightly bound to particular data structures and processing flows. The server and terminal together control physical devices such as cameras, displays, speakers, and network interfaces and interact with external delivery infrastructure. The internal use of structured prompt sentences, unified ingredient and preference representations, and emotion-based adjustment transforms the generative model from a generic text generator into a constrained computational component in a larger technical system. This yields improved processing efficiency, enhanced robustness, and superior adaptability compared with conventional systems that rely on static rules, manual input, or ad hoc AI integration.

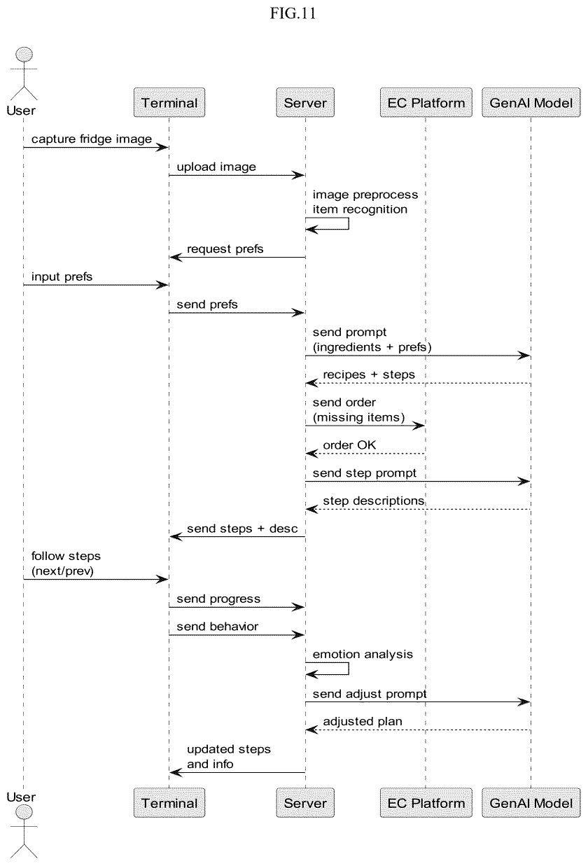

The following describes the processing flow using FIG. 11.

### Step 1:

User operates the terminal to capture an image of the interior of the storage apparatus.

User opens the storage apparatus door, arranges items so that they are visible, and points the terminal's imaging unit toward the interior.

Terminal activates the imaging unit via an operating system camera interface and displays a live preview on the display.

User presses a capture control on the terminal's screen.

Terminal acquires raw sensor data, encodes the data into compressed image data, and stores the image file in local storage.

Input: physical scene inside the storage apparatus.

Output: digital image data file stored in the terminal.

### Step 2:

User operates the terminal to upload the stored image data to the server.

User launches a dedicated application on the terminal and selects the stored image from a gallery view.

Terminal reads the image file from local storage, establishes a secure communication session with the server, and transmits the image data as a request payload.

Server receives the request, verifies user identification information, and stores the received image data in server-side storage.

Input: image data file on the terminal.

Output: image data stored in server memory or persistent storage, associated with the user.

### Step 3:

Server executes image preprocessing and item recognition on the received image data.

Server loads the image data into memory and applies an image processing program to resize the image, convert color channels, and normalize pixel values into a tensor.

Server feeds the tensor into an item recognition model implemented as a convolutional neural network, which performs convolution, activation, pooling, and fully connected operations to compute classification probabilities and optional object locations.

Server applies a confidence threshold, aggregates detections belonging to the same abstract category, and estimates the quantity of each category.

Server generates item list data containing category identifiers and quantity values and stores the item list data in a database.

Input: raw image data from the storage apparatus interior.

Output: structured item list data representing detected article categories and quantities.

### Step 4:

User operates the terminal to input meal preference information.

User enters free-form text such as a desired cuisine or selects structured options such as number of persons and time constraints.

Terminal captures the text or selection data, formats it as a preference message, and transmits the message to the server.

Server receives the preference message and passes the textual content to a natural language processing module, which performs tokenization, syntactic analysis, and slot filling to extract standardized attributes such as meal type, serving count, and allowed cooking time.

Server constructs standardized preference data from these attributes and stores the standardized preference data in the database.

Input: user-generated preference text or selection data.

Output: standardized preference data with normalized fields used by subsequent processing.

### Step 5:

Server combines the item list data and the standardized preference data to generate a first prompt sentence for a generative AI model.

Server retrieves the item list data and standardized preference data associated with the current user session.

Server constructs a textual prompt sentence that lists the available ingredients as abstract category names, describes the user's cooking preferences, and specifies the desired output structure.

For example, server generates a prompt sentence such as:

“Available ingredients in the refrigerator: salmon, tofu, eggs, carrots. The user wants to eat Japanese food tonight for two people and prefers simple dishes that can be prepared within 30 minutes. Propose one or more recipes that maximize the use of these ingredients. For each recipe, output the title, list of ingredients with quantities, and detailed step-by-step cooking instructions with estimated time for each step. Also list any missing ingredients that must be purchased.”

Server formats this prompt sentence according to the tokenization and length constraints of the generative AI model.

Input: item list data and standardized preference data.

Output: structured prompt sentence text prepared for the generative AI model.

### Step 6:

Server uses the generative AI model to generate cooking procedure data from the prompt sentence.

Server encodes the prompt sentence into tokens and feeds the tokens into a transformer-based generative AI model configured for text generation.

Server runs the model to compute attention-based hidden states and next-token probability distributions, and iteratively samples or selects tokens to build output text that describes recipes, ingredient lists, and step-by-step instructions.

Server receives the generated text and parses it according to predefined markers or sections, extracting recipe titles, ingredient requirement information, and numbered step descriptions.

Server converts the parsed elements into structured cooking procedure data, which includes one or more recipe objects and associated step objects, and stores this data in the database.

Input: prompt sentence text.

Output: structured cooking procedure data representing recipes and steps.

### Step 7:

Server determines candidate insufficient ingredients by comparing ingredient requirement information with the item list data, and prepares order data.

Server retrieves from the cooking procedure data the list of required ingredients and their quantities.

Server compares these requirements with the quantities in the item list data by matching abstract category identifiers and subtracting available quantities from required quantities.

Server identifies any ingredients with missing or insufficient quantities and constructs a candidate insufficient ingredient list.

Server maps each candidate insufficient ingredient to product category information used by an electronic commerce platform, using a mapping table or learned embedding.

Server generates order data including product identifiers, quantities, delivery destination information, and desired delivery time information, and transmits the order data through an application programming interface to the commerce platform.

Input: cooking procedure data and item list data.

Output: candidate insufficient ingredient list and transmitted order data for external commerce processing.

### Step 8:

Server generates presentation description data for each cooking step by using a second prompt sentence to the generative AI model.

Server iterates over each step in the cooking procedure data and extracts step structure data, including the step content, required time, and referenced ingredients.

Server constructs a presentation prompt sentence for each step, for example:

“Explain the following cooking step in simple language suitable for a beginner cook. Step: ‘Sprinkle salt on the salmon fillets and let them rest for 10 minutes.’ Include a brief explanation of why this step is important, and keep the explanation within three sentences.”

Server encodes each presentation prompt sentence and sends it to the generative AI model, which produces explanatory text for that step.

Server collects the generated explanations as description data, associates them with the corresponding steps, and forms presentation description data objects that are suitable for display or speech output.

Input: cooking procedure data with step structure data.

Output: presentation description data providing human-readable explanations of each step.

### Step 9:

Server transmits the cooking procedure data and the presentation description data to the terminal, and the terminal presents them stepwise.

Server packages the structured cooking procedure data and associated presentation description data into a response message and sends the message to the terminal.

Terminal receives the message, parses the structured data, and constructs user interface elements such as a list of recipes, step indicators, and navigation controls.

User selects a recipe on the terminal, and the terminal displays the first step along with its explanatory description text, and optionally converts the text to speech for audio output.

Terminal waits for user input, such as tapping a “Next” button, and then replaces the displayed content with the next step and its description.

Input: cooking procedure data and presentation description data from the server.

Output: user-facing stepwise cooking guidance displayed and/or spoken on the terminal.

### Step 10:

Terminal and server cooperate to track progress status data during cooking.

Terminal records user interactions such as step completion events and timestamps when the user indicates that a step has been completed.

Terminal packages the current step index, elapsed time, and any user feedback into progress status data and transmits this data to the server.

Server receives the progress status data and updates a session record in the database, marking which steps have been completed and when.

Server may use this updated state to adjust timing of notifications, align delivery timing of ordered ingredients, or prepare further adjustments of instructions if delays occur.

Input: user interaction events on the terminal.

Output: updated progress status data stored on the server for the current cooking session.

### Step 11:

Terminal and server acquire and process behavior data to estimate the user's emotional state.

Terminal activates sensors such as a microphone and a front-facing camera to capture voice signals and facial images during interaction, and, if available, obtains motion signals from built-in motion sensors or external devices.

Terminal encodes and compresses the captured signals as behavior data and transmits the behavior data to the server.

Server receives the behavior data and applies trained models, such as a convolutional network for facial expressions, a temporal model for prosody and voice energy patterns, and a sequence model for motion features, to compute intermediate feature vectors.

Server fuses these feature vectors using a learned classifier to produce an emotional state estimate, such as a distribution over emotional categories or a multi-dimensional affective vector.

Input: multimodal behavior data from sensors.

Output: estimated emotional state associated with the user and current session.

### Step 12:

Server generates an adjustment prompt sentence based on the emotional state, item list data, and standardized preference data, and updates the cooking procedure data and order data.

Server retrieves the current cooking procedure data, item list data, standardized preference data, and estimated emotional state.

Server forms an adjustment prompt sentence such as:

“The current cooking plan includes the following recipes and steps: [summary]. The user appears tired and has limited attention. Adjust the cooking procedures to reduce overall cooking time and simplify the steps, while still using the available ingredients. Indicate which steps can be skipped or merged, and update the required ingredients accordingly.”

Server encodes and sends the adjustment prompt sentence, along with structured summaries of the current procedures, to the generative AI model, which outputs adjustment result data specifying modifications to steps and ingredient usage.

Server parses the adjustment result data to determine which steps to remove, combine, or annotate, and updates the stored cooking procedure data accordingly.

Server also updates the order data, for example by canceling orders for ingredients no longer needed or changing quantities, and transmits updated order information to the commerce platform if necessary.

Input: emotional state, cooking procedure data, item list data, standardized preference data.

Output: adjusted cooking procedure data and, if applicable, updated order data reflecting emotion-based modifications.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented cooking assistance systems generally operate as static recipe search engines, in which a user manually inputs available ingredients and search conditions, and a server returns pre-stored recipes. Such systems lack integration among multiple technical subsystems, including visual recognition of stored items, natural language understanding of user preferences, adaptive text generation of procedural instructions, and automated coordination with electronic commerce platforms. As a result, these systems require substantial manual input, are brittle when handling natural language preferences, and are unable to reliably maintain an accurate model of real-time inventory in a storage apparatus such as a refrigerator.

Furthermore, in many existing systems, processing pipelines are fragmented. Image capture is performed independently on a user terminal, image recognition is performed in an isolated module, and recipe recommendation logic is hard-coded and not dynamically adapted to inventory changes or user emotional state. This fragmentation produces several technical problems: (i) the server cannot systematically generate machine-optimizable representations (such as structured prompt sentences) that fully leverage generative AI models; (ii) the server cannot automatically close the loop between recognized inventory, generated recipes, missing-item detection, and order placement via external application programming interfaces; and (iii) the server cannot dynamically adjust cooking procedures in response to user feedback signals derived from multimodal sensor data, such as voice tone, facial expression, or body motion. Additionally, conventional systems typically treat generative AI models as black-box text generators, invoked with ad hoc user messages. Without structured prompt construction on the server side, the generated output often lacks the precision, consistency, and machine-readability required to drive accurate ingredient comparison, missing-item detection, and electronic order generation. This leads to technical inefficiencies such as repeated parsing failures, error-prone mapping between generated text and database entities, and increased server-side computation for error handling and user re-prompting.

Moreover, many existing architectures do not exploit user emotional state as a computational signal in the control loop of the cooking support system. Emotional signals from voice, image, or motion data are either ignored or processed only for superficial user interface adaptation, without being integrated into a server-side data model that controls recipe difficulty, cooking time, or ordering behavior. This omission reduces the ability of the system to optimize computational decision-making and to tailor the output of generative AI models in a way that reduces user abandonment and repeated interactions, which in turn increases overall system load.

Accordingly, there is a need for an improved computer-implemented system and server-side processing architecture that: (1) tightly integrates image acquisition and machine learning-based item recognition for storage apparatus inventory; (2) converts heterogeneous user inputs into standardized meal condition data; (3) programmatically constructs structured prompt sentences to drive a generative AI model for generating cooking procedure data and explanation data; (4) automatically detects missing items by comparing generated requirements against recognized inventory; (5) generates and transmits order data via an external application programming interface to obtain delivery schedule information; and (6) incorporates user emotional state into a closed-loop control mechanism that adjusts generative AI outputs, thereby improving the technical performance, robustness, and automation level of the overall cooking assistance system.

The specific processing by the specific processing unit 290 of the data processing device 12 in Application Example 1 is realized by the following means.

The present invention provides a server comprising a processor configured to control an image acquisition unit to acquire an image of a storage apparatus and to store the image as digital data; to analyze the stored image data by using a machine learning model in order to identify items present in the storage apparatus and to specify at least a type, a quantity, and a storage state of each of the items; to acquire a user input including at least one of voice input, text input, and selection input regarding a meal preference and to standardize a content of the user input into meal condition data by using natural language processing; to construct a structured prompt sentence including item information identified from the storage apparatus and the meal condition data, and to input the prompt sentence into a generative AI model to cause the generative AI model to generate cooking procedure data; to analyze the cooking procedure data to extract information on required items, to compare the information on required items with the item information identified from the storage apparatus, and to specify insufficient items as missing items; to generate order data for the missing items, to transmit the order data to an external delivery service via an external communication interface in accordance with an application programming interface of the external delivery service, and to acquire delivery schedule information from the external delivery service; to analyze step information included in the cooking procedure data, to construct an explanation prompt sentence for the generative AI model, and to cause the generative AI model to generate explanation data for visual presentation or auditory presentation to a user based on the explanation prompt sentence; to acquire user state data including at least one of voice data, image data, and motion data of the user and to input the user state data into a machine learning model to estimate an emotional state of the user; to construct an adjustment prompt sentence based on at least the emotional state, the item information, the meal condition data, and the delivery schedule information, the adjustment prompt sentence being configured to adjust at least one of content of the cooking procedure, selection of items, difficulty of cooking, cooking time, and order content, and to input the adjustment prompt sentence into the generative AI model to cause the generative AI model to generate adjustment result data; and to integrate the explanation data and the adjustment result data to generate integrated presentation information including recipe information, inventory status, order status of the missing items, and the delivery schedule information, and to transmit the integrated presentation information to a user terminal for presentation to the user. This enables an integrated and automated server-side processing pipeline in which inventory recognition, preference understanding, generative AI-based cooking procedure generation, missing-item detection, electronic ordering, and emotion-driven adaptive adjustment are performed in a coordinated manner, thereby improving the technical efficiency, reliability, and responsiveness of a computer-implemented cooking assistance system.

The term “processor” refers to a hardware computation unit, such as a central processing unit or a graphics processing unit, and may include one or more cores or processing elements configured to execute instructions that implement the functions described in the claims.

The term “image acquisition unit” refers to a hardware and software combination configured to capture an image of a physical environment, including at least an imaging sensor, an optical system, and a control interface, and may be embodied by an imaging device of a portable user terminal.

The term “storage apparatus” refers to a physical container or device configured to store items under controlled conditions, including but not limited to a refrigeration appliance, a freezer, a pantry cabinet, or a similar storage device used for storing food or other goods.

The term “digital data” refers to information represented in a discrete numeric format suitable for processing by electronic circuitry, including at least pixel data of images, encoded text data, structured data records, and metadata associated with such information.

The term “machine learning model” refers to a computational model generated through a training process on data, including but not limited to neural network models, decision tree models, or ensemble models, and configured to perform tasks such as classification, detection, or estimation based on input data.

The term “item” refers to a physical article stored in the storage apparatus, including but not limited to a food product, a container, a package, or another stored good, which can be identified and characterized by the system.

The term “type” refers to categorical information describing a class or category of an item, such as a kind of ingredient, a kind of product, or a kind of material that the item belongs to.

The term “quantity” refers to information indicating an amount or number associated with an item, which may be expressed in units such as pieces, weight, volume, or other measurable units.

The term “storage state” refers to information indicating a condition or status of an item within the storage apparatus, including at least presence, approximate remaining amount, freshness, or category of storage location.

The term “user input” refers to information provided by a user to the system through one or more input modalities, including voice input, text input, selection input, or other interactive input methods.

The term “voice input” refers to audio information representing spoken utterances of a user, acquired through a microphone or similar audio sensing device and optionally converted to text by speech recognition processing.

The term “text input” refers to character-based or symbol-based information entered by a user through an input interface, including keyboard input, touch-based text entry, or selection of pre-defined textual options.

The term “selection input” refers to user interaction that selects one or more options from a set of presented choices, including button presses, menu selections, toggle operations, or similar selection actions.

The term “meal preference” refers to user-desired conditions or requirements for a meal, including at least food category, cuisine type, main ingredient, dietary restriction, cooking time, or difficulty level.

The term “natural language processing” refers to computational techniques for analyzing, interpreting, and transforming text or speech data in human language into structured representations, including tokenization, parsing, entity recognition, intent detection, and related operations.

The term “meal condition data” refers to standardized and structured data representing the content of the user's meal preference, expressed in a form suitable for programmatic processing, matching, and prompt construction.

The term “prompt sentence” refers to a text sequence provided as input to a generative AI model, the text sequence including instructions, context, and constraints that guide the generative AI model to produce desired output.

The term “structured prompt sentence” refers to a prompt sentence having a predefined internal organization, such as labeled sections or explicit markers, enabling consistent interpretation and parsing of the generative AI model's output.

The term “generative AI model” refers to an artificial intelligence model configured to generate output data, including at least natural language text, based on input data and learned parameters, and typically implemented as a neural network-based sequence model.

The term “cooking procedure data” refers to data representing a sequence of operations for preparing a meal, including step descriptions, required items, cooking times, and related procedural information, generated at least in part by a generative AI model.

The term “required items” refers to items that are specified by the cooking procedure data as necessary for executing a cooking procedure, including ingredients, tools, or consumable materials.

The term “missing items” refers to items that are included in the required items but are not present, or are present in insufficient quantity, in the storage apparatus as determined by comparison processing.

The term “order data” refers to structured information representing a request to procure missing items, including at least item identifiers, quantities, delivery address information, and requested delivery timing.

The term “external delivery service” refers to an external computerized service configured to receive order data, process orders, and arrange delivery of physical items to a user, and may include an electronic commerce platform or a logistics service.

The term “external communication interface” refers to hardware and software components enabling data communication between the server and external systems, including network interfaces, communication protocols, and associated control logic.

The term “application programming interface” refers to a defined set of rules, endpoints, data formats, and authentication mechanisms used by a software system to interact programmatically with another system.

The term “delivery schedule information” refers to information indicating at least a planned delivery time or time window for items ordered through the external delivery service, and may include order status information.

The term “step information” refers to individual procedural elements or stages within the cooking procedure data, each corresponding to a specific operation to be performed when preparing a meal.

The term “explanation prompt sentence” refers to a prompt sentence configured to instruct a generative AI model to generate explanation data describing one or more steps of the cooking procedure in a form suitable for user presentation.

The term “explanation data” refers to generated information that describes cooking steps, hints, or contextual details in a manner suitable for visual or auditory presentation to the user.

The term “visual presentation” refers to output presented to the user in graphical or textual form via a display device, including screens of portable terminals or other image display apparatuses.

The term “auditory presentation” refers to output presented to the user as sound via an audio output device, such as a speaker or earphone, and may include synthesized speech based on explanation data.

The term “user state data” refers to sensor-acquired information related to a user, including at least voice data, image data, and motion data, which collectively represent observable aspects of the user's state.

The term “voice data” refers to audio signals capturing sounds produced by the user, including speech and paralinguistic features such as tone and intonation.

The term “image data” refers to visual signals capturing the appearance of the user or surroundings, obtained from an imaging sensor such as a camera.

The term “motion data” refers to signals representing movement of the user or a device associated with the user, including data from inertial sensors, cameras, or other motion-sensing components.

The term “emotional state” refers to an inferred condition of a user's affect or mood, such as happiness, frustration, or stress, estimated by applying a machine learning model to user state data.

The term “adjustment prompt sentence” refers to a prompt sentence configured to instruct a generative AI model to modify or adjust at least one aspect of the cooking procedure, item selection, difficulty, cooking time, or order content based on contextual information including the emotional state.

The term “adjustment result data” refers to information generated by the generative AI model in response to the adjustment prompt sentence, the information indicating modifications to be applied to the cooking procedure, item use, or ordering behavior.

The term “integrated presentation information” refers to combined data prepared for user presentation, including at least recipe information, inventory status, order status of missing items, and delivery schedule information, organized in a unified format.

The term “recipe information” refers to information describing a suggested meal preparation process, including at least a recipe title, list of required items, and ordered cooking steps.

The term “inventory status” refers to information indicating which items are currently recognized as being present, absent, or scheduled to arrive in relation to the storage apparatus.

The term “order status” refers to information indicating a state of processing for an order of missing items, including at least acceptance, preparation, shipment, or estimated completion.

The term “user terminal” refers to an electronic device operated by a user, including at least a portable information terminal, a smartphone, a tablet, or a personal computer, configured to communicate with the server and present information to the user.

In one embodiment, a server cooperates with a terminal operated by a user and with one or more external delivery services to implement a cooking assistance system. The server executes software modules including an image analysis module, a natural language processing module, a prompt construction module, a generative AI interface module, an inventory management module, an order management module, an emotion estimation module, and a presentation generation module. The terminal includes at least an imaging unit, a microphone, a display, one or more motion sensors, local storage, and a communication interface.

The terminal captures an image of a storage apparatus, such as a refrigerator or pantry, by using an integrated camera module controlled by an operating system such as a mobile operating system. The terminal may execute a native camera application or a dedicated application that accesses a camera application programming interface. The terminal stores the captured image as digital data, for example in JPEG or PNG format, and transmits the digital data to the server through a communication network using a secure protocol such as HTTPS.

The server receives the digital image data and stores the image in a storage subsystem, which may include a non-volatile storage device or a networked storage service. The server reads the image data into memory and processes the image by using an image processing library such as an implementation of OpenCV. The server converts the color space to a standard format, resizes the image to a predetermined resolution (for example, 640×640 pixels), and normalizes pixel values such that each pixel intensity lies within a specified numeric range. The server may apply additional preprocessing operations such as histogram equalization, noise reduction, and contrast enhancement. These preprocessing operations reduce computational variability and improve the convergence characteristics of subsequent neural network inference, thus increasing recognition accuracy and lowering the number of misclassifications.

The server identifies items in the storage apparatus by applying a machine learning model to the preprocessed image. In one embodiment, the server uses a convolutional neural network or a transformer-based vision model deployed by a machine learning framework such as a generic deep learning framework. The server loads a trained network whose architecture includes multiple convolutional layers, nonlinear activation layers, pooling layers, and fully connected layers, or includes self-attention layers in the case of a transformer-type architecture. The server uses image regions as input features, where each region is represented as a tensor of pixel intensities. The server performs forward propagation of the input tensor through the network, computing weighted sums and non-linear activations layer by layer. The server outputs, for each candidate region, a set of class probabilities and bounding box coordinates.

The server applies a post-processing algorithm including non-maximum suppression to the raw detection outputs. The server eliminates overlapping bounding boxes for the same class when a lower-confidence box overlaps a higher-confidence box beyond a threshold intersection-over-union ratio. The server discards detections with class probabilities below a confidence threshold.

The server maps the remaining class indices to generic item categories stored in a label mapping table, such as “fish,” “leafy vegetable,” “dairy product,” or “condiment,” which are higher-level concepts than specific brand names. The server estimates quantities by considering the size of each detected region relative to the image or by counting instances of the same category.

In an alternative embodiment, the server extracts textual label information from the image by applying optical character recognition. The server isolates candidate label regions by edge detection and connected-component analysis, and then applies a character recognition model to each region. The server decodes the recognized characters into product category names, storage dates, or expiration dates, which are then normalized into structured records. By combining object detection outputs and character recognition outputs, the server improves item identification accuracy and reduces ambiguity between visually similar items.

The server maintains an inventory database in which each record includes at least a user identifier, an item type, a quantity, and a storage state. The server updates inventory records by comparing newly detected item categories and quantities with existing records. The server increases or decreases quantities, inserts new item records, and marks items as depleted when they are no longer detected in consecutive images. The server uses structured database operations and indexing of item categories to accelerate lookups and comparisons, which reduces latency for subsequent recipe generation logic.

The terminal acquires a meal preference from the user. The user may speak into a microphone, enter text via a keyboard or touch screen, or select options from a graphical user interface, such as “Japanese cuisine,” “fish-based dinner,” “low-sodium,” or “under 20 minutes.” The terminal transmits the meal preference to the server as text data. When the user provides voice input, the terminal or the server performs speech-to-text conversion by using a speech recognition engine, and the resulting text is processed uniformly with other textual inputs.

The server standardizes the meal preference by applying natural language processing. The server tokenizes the text into word units, applies part-of-speech tagging, and identifies keyword entities such as cuisine types, main ingredients, dietary restrictions, and time constraints. The server maps these entities to normalized codes stored in a preference schema, generating meal condition data. For example, the server may convert “I want to eat Japanese food using fish” into structured descriptors such as “cuisine: Japanese,” “main category: fish,” “time constraint: not specified.” This standardized representation of the meal preference improves computational efficiency and enables consistent prompt generation.

The server constructs a prompt sentence for interaction with a generative AI model. The server uses a prompt construction module that arranges template segments and dynamic content into a structured textual instruction. The server includes machine-readable section markers, such as headings and delimiters, to separate lists of available items, user preferences, and required output formats. The server describes the identified inventory in a generalized form, such as “fish fillet, leafy vegetable, fermented seasoning,” and lists any contextual constraints derived from the meal condition data.

In one example, the server constructs a prompt sentence such as:

“You are a cooking assistant. The user's storage apparatus currently contains: salmon fillet, spinach, soy-based seasoning, butter. The user prefers Japanese cuisine using fish. Propose one or more detailed recipes with clear step-by-step instructions. For each recipe, list the required ingredients with quantities, indicate which ingredients are already available, and identify any additional ingredients that are missing and should be purchased. Format the output with sections titled ‘Recipe Title,’ ‘Ingredients,’ ‘Steps,’ and ‘Missing Items.’”

In another example, the server constructs a prompt sentence such as:

“The system has detected the following items in the storage apparatus: eggs, tofu, spinach, soy-based seasoning, sweet cooking seasoning. The user says: ‘I want to eat healthy Japanese food tonight.’ Generate three recipe suggestions. For each suggestion, output a title, a short description, total cooking time, difficulty level, and a list of missing ingredients. Clearly separate each recipe with a header line starting with ‘Recipe:’ so that the text can be parsed programmatically.”

The server transmits the constructed prompt sentence to a generative AI model. In one embodiment, the generative AI model is a transformer-based language model that applies multi-head self-attention, feed-forward layers, and layer normalization to sequences of tokenized text. The server encodes the prompt as tokens, sets parameters such as generation length and temperature, and executes inference using a hardware accelerator such as a graphics processing unit. The server receives generated tokens from the generative AI model and reconstructs them into text, which constitutes cooking procedure data.

The server parses the generated cooking procedure data to derive structured information. The server locates designated section headers, such as “Ingredients” and “Steps,” by string matching or regular expressions, and then parses ingredient lines into item categories and numeric quantities. The server normalizes ingredient names through mapping tables that associate linguistic variants to canonical item types. By using a structured prompt and predictable output sections, the server reduces parsing errors and improves the robustness of the transformation from generated text into machine-usable data structures. This structured approach improves computational efficiency and reduces the need for corrective user interaction.

The server determines missing items by comparing required ingredients extracted from the cooking procedure data with the updated inventory database. The server performs set operations and quantity comparisons to determine whether each required item is present and whether the stored quantity is sufficient. When a shortage is detected, the server adds an entry to a missing-item list. The server stores the missing-item list as part of the internal data structure associated with the current cooking session.

The server generates order data for the missing items. The server maps each missing item category to a generic product identifier recognized by an external delivery service, determines appropriate package sizes and quantities, and constructs an order structure containing user delivery address, requested delivery time, and item lines. The server selects a delivery time based on previously stored user availability or explicit user settings. The server formats the order structure according to the external delivery service application programming interface specification, including authentication tokens and endpoint information.

The server transmits the order data through a network interface and receives delivery schedule information in response. The server writes the order identifier, expected delivery window, and current order state to the database. By programmatically generating and transmitting order data directly from recognized inventory and generated recipe data, the system reduces human error and manual transcription overhead, and also reduces communication round trips between user and server.

The server produces explanation data suitable for user presentation. The server extracts step information from the cooking procedure data and creates an explanation prompt sentence. For example, the server may construct a prompt sentence such as:

“Rewrite the following cooking steps in a concise and beginner-friendly manner, adding short justifications where necessary. Keep each step on a separate line and use plain language: [steps extracted here].”

The server sends this explanation prompt sentence to the generative AI model and receives refined, human-readable explanation text. The server may produce both short and detailed variants for different presentation modes, such as on-screen text and synthesized speech.

The terminal acquires user state data for emotional estimation. The terminal captures audio data of the user's voice during interaction, video frames from a camera pointed at the user, and motion data from an inertial sensor. The terminal encrypts and transmits these signals or derived feature vectors to the server. The server applies an emotion estimation model, which may be a neural network trained on multimodal inputs. The server extracts features such as pitch, volume, and speech rate from the voice data, facial action units and facial landmarks from the image data, and acceleration patterns from the motion data. The server concatenates these features into a feature vector and passes the feature vector through the emotion estimation network, which outputs a probability distribution over emotional classes such as “relaxed,” “stressed,” “confident,” or “confused.”

The server constructs an adjustment prompt sentence based on the estimated emotional state, the inventory state, the meal condition data, and the delivery schedule information. For example, when the user is estimated to be stressed and there is limited time before delivery of missing items, the server may construct a prompt sentence such as:

“The user appears to be stressed and has limited time. Simplify the following recipe by reducing the number of steps and using fewer utensils, while still producing an acceptable result. Indicate any steps that can be skipped without significantly degrading the dish: [original recipe steps].”

The server sends this adjustment prompt sentence to the generative AI model and obtains adjustment result data, which may include simplified instructions, reduced ingredient lists, or alternative preparation methods.

The server integrates the explanation data and the adjustment result data into integrated presentation information. The server creates a data object linking a selected recipe title, ingredient availability status, missing-item order status, delivery schedule, and adjusted procedure steps. The server transmits this integrated presentation information to the terminal in a structured but implementation-neutral format. The terminal renders the integrated information via the display, showing which steps can be started immediately using existing inventory and indicating an estimated time at which ordered items will arrive.

The server, by performing the above operations, achieves technical improvements beyond mere automation of human planning. The server reduces recognition errors by combining learned image features and character-recognized labels; the server improves computational efficiency by using structured prompt sentences that constrain generative AI output into parseable sections; and the server decreases network traffic and user interaction overhead by automatically driving the entire pipeline from image capture to order placement. The server uses specialized neural architectures with trained parameters and precise thresholds for filtering predictions, which collectively reduce misclassification rates and lower the need for manual correction. The system also improves data management by maintaining synchronized inventory records that are automatically updated from sensor inputs instead of relying on manual entry.

The generative AI model is trained with instruction-following objectives and may be fine-tuned on a corpus of recipe texts. During training, the server or a training environment minimizes an objective function such as cross-entropy loss between predicted tokens and ground-truth texts, updating network weights with gradient-based optimization. The use of explicit prompt formats and output constraints in deployment differentiates the system from generic text generation and yields more stable and predictable behavior, which directly improves the ability of the server to automate follow-on computational tasks such as ingredient normalization, missing-item detection, and order generation.

In a further embodiment, the server compresses and caches intermediate representations, such as preprocessed image tensors and meal condition data, to avoid recomputation when similar queries occur. The server may also schedule batch inference for image recognition and generative AI calls, thereby utilizing hardware accelerators more efficiently and reducing average processing time. The server may employ alternative network architectures, such as lightweight convolutional networks for resource-constrained environments or larger transformer-based networks for high-capacity servers.

The terminal may present alternative user interface layouts, such as a step-focused view in which only the current step and a small set of future steps are shown, or a timeline view that aligns cooking steps with delivery arrival times. The user may switch between recipes suggested by the server, and the server may recompute missing items and adjustment prompts dynamically without requiring repeated image capture.

By structuring data flows, specifying detailed machine learning architectures and training procedures, and designing non-conventional prompt sentence formats that directly support downstream algorithmic processing, the system produces technical effects such as improved recognition precision, reduced latency, better resource utilization on the server hardware, and lower communication overhead between the terminal and the server. The integration of emotional state estimation into the control loop further enables the server to optimize recipe complexity and interaction length, which reduces abandoned sessions and therefore improves overall computational throughput.

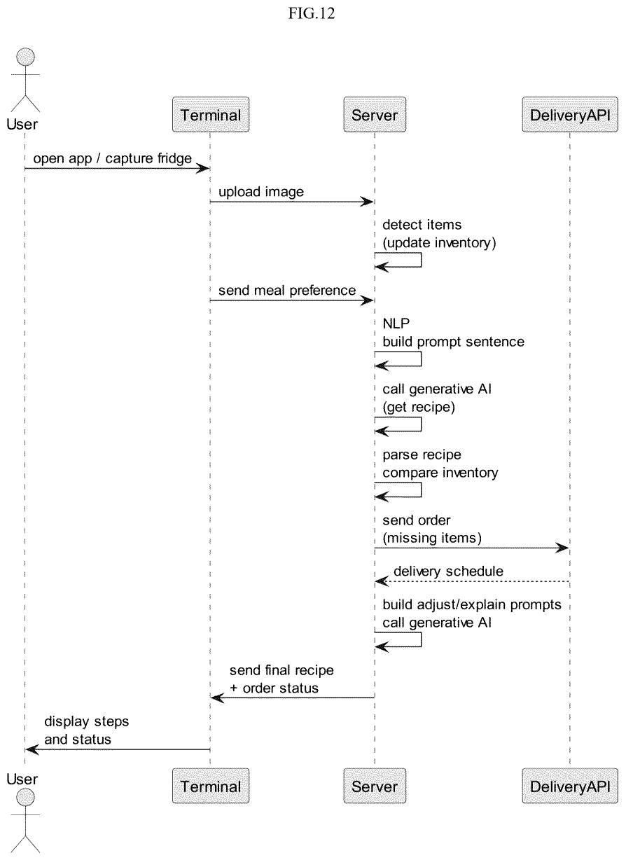

The following describes the processing flow using FIG. 12.

### Step 1:

The user positions a storage apparatus, such as a refrigerator, within the field of view of the terminal.

The terminal activates an imaging unit under control of an operating system and displays a live preview on a display.

The user adjusts the angle and distance so that items in the storage apparatus are visible and triggers a capture command via a touch input or button press.

Input: Light reflected from the interior of the storage apparatus, converted into raw sensor signals by the imaging unit.

Output: A digital image file, for example in JPEG or PNG format, stored temporarily in local storage of the terminal.

The terminal converts the raw sensor signals into a compressed digital image using an image encoding algorithm and assigns metadata such as capture time and device identifier.

### Step 2:

The terminal establishes a secure communication session with the server via a network interface using a protocol such as HTTPS.

The terminal reads the stored digital image file and packages the image together with metadata, such as user identifier and image format, into a transmission payload.

Input: The digital image file and associated metadata stored on the terminal.

Output: A network request containing the digital image data and metadata, transmitted to the server.

The terminal sends the request to a predefined server endpoint and waits for acknowledgment, handling retries if a network error occurs.

### Step 3:

The server receives the network request and verifies integrity and authenticity of the payload.

The server extracts the digital image data and metadata, and stores the image data in a storage subsystem such as a file system or object store.

Input: The digital image data and metadata contained in the network request.

Output: A stored image reference, such as a file path or object key, and an in-memory image buffer for processing.

The server logs reception of the image and associates the stored image reference with the user identifier in a database.

### Step 4:

The server loads the image from the storage subsystem into main memory and decodes the compressed format into a raw pixel array.

The server applies preprocessing operations such as resizing, color space conversion, and normalization using an image-processing library.

Input: The decoded pixel array representing the captured scene.

Output: A preprocessed image tensor with standardized size and numeric range suitable for neural network inference.

The server may additionally apply noise reduction or contrast enhancement algorithms, transforming the pixel values to improve separation of item boundaries and label readability.

### Step 5:

The server applies a machine learning model, such as a convolutional neural network or a vision transformer, to the preprocessed image tensor.

The server performs forward propagation through multiple layers, computing feature maps and class scores for different regions of the image.

Input: The preprocessed image tensor.

Output: A set of detection results including potential item categories, confidence scores, and bounding box coordinates.

The server then applies post-processing, including non-maximum suppression and confidence thresholding, to filter the raw detection results into a refined list of identified item regions.

### Step 6:

The server maps the detected categories to generalized item types and estimates quantities based on the number and size of bounding boxes.

The server optionally performs optical character recognition on label regions to extract textual information such as item type or expiration date, and merges these results with the detection results.

Input: The refined list of detected item regions and, optionally, recognized character strings from label regions.

Output: A structured item list including an item type, an estimated quantity, and an optional storage state or expiration date for each item.

The server converts low-level detection outputs into a standardized data structure that can be stored and queried efficiently.

### Step 7:

The server retrieves existing inventory records for the user from a database and compares these records with the newly generated structured item list.

The server computes differences by matching item types and quantifying increases or decreases in quantities.

Input: The structured item list derived from the current image and the prior inventory records from the database.

Output: An updated inventory dataset that reflects current item availability and inferred changes, such as consumption or restocking.

The server writes updated records back to the database and may mark items as depleted if they have not appeared in several consecutive updates.

### Step 8:

The terminal presents an interface for meal preference input and prompts the user to describe a desired meal.

The user enters text, selects options, or speaks into a microphone to express preferences such as cuisine type, main ingredient, dietary restrictions, or time constraints.

Input: Spoken utterances, typed text, or selection events from the user.

Output: A textual representation of the meal preference stored on the terminal.

The terminal converts voice input into text using a speech recognition component if necessary, and sends the resulting text string to the server via a network request.

### Step 9:

The server receives the meal preference text and applies natural language processing to extract structured attributes.

The server tokenizes the text, identifies key phrases, and maps them to standardized descriptors such as cuisine category or main ingredient category.

Input: The meal preference text received from the terminal.

Output: Meal condition data represented as a set of standardized fields that encode the user's preferences.

The server records the meal condition data in association with the current user and session context in the database.

### Step 10:

The server retrieves the latest inventory dataset and the meal condition data, and combines them to construct a prompt sentence for a generative AI model.

The server arranges the inventory information, preference descriptors, and output format instructions into a structured, human-readable text sequence.

Input: The inventory dataset and the meal condition data.

Output: A structured prompt sentence that describes available items, user constraints, and required output format.

The server inserts explicit markers or section titles within the prompt sentence to facilitate reliable parsing of the generated output.

### Step 11:

The server sends the structured prompt sentence to a generative AI model by invoking a model interface or an external model service.

The server encodes the prompt as tokens, sets generation parameters, and executes inference on a hardware accelerator as needed.

Input: The structured prompt sentence.

Output: Generated cooking procedure data including at least one recipe title, a list of required ingredients, and a sequence of cooking steps expressed as text.

The server receives the generated text from the generative AI model and reconstructs a continuous textual document from the token stream.

### Step 12:

The server parses the cooking procedure data to extract an ingredient list and step information.

The server locates predefined section labels, splits the text into sections, and transforms ingredient lines into structured records containing item types and quantities.

Input: The raw textual cooking procedure data produced by the generative AI model.

Output: A structured recipe representation including a required-ingredient list and an ordered list of step descriptions.

The server normalizes ingredient names by mapping linguistic variants to canonical item types using an internal mapping table.

### Step 13:

The server compares the required-ingredient list with the updated inventory dataset to determine which items are fully available, partially available, or missing.

The server performs set-difference and quantity-comparison operations for each required item type.

Input: The structured required-ingredient list and the updated inventory dataset.

Output: A list of missing items and a list of available items, each with associated quantities and statuses.

The server tags items in the recipe data structure with availability flags so that subsequent modules can handle them appropriately.

### Step 14:

The server constructs order data for the missing items by mapping item types to product identifiers recognized by an external delivery service.

The server determines required package quantities and associates user delivery information and requested delivery time.

Input: The list of missing items, user delivery profile, and optional timing constraints.

Output: A fully populated order structure that conforms to the external delivery service application programming interface.

The server serializes this order structure into a network request and transmits it to the external delivery service, then receives and stores delivery schedule information in response.

### Step 15:

The terminal captures user state data related to emotional condition.

The user interacts with the terminal while the terminal records voice characteristics, facial expressions via the camera, and motion patterns via sensors.

Input: Continuous audio signals, image frames, and motion sensor readings associated with the user.

Output: User state data streams that the terminal forwards to the server, or feature vectors derived from these streams.

The terminal may preprocess these signals by downsampling, compressing, or extracting basic features to reduce communication load.

### Step 16:

The server receives the user state data or feature vectors and applies an emotion estimation model.

The server computes features such as pitch and energy from audio, facial landmark movements from images, and acceleration statistics from motion data, then feeds these features into a neural network trained for emotion classification.

Input: The user state data or preprocessed feature vectors.

Output: An estimated emotional state represented as a probability distribution or a selected emotional label.

The server records the estimated emotional state along with a timestamp and associates it with the active cooking session.

### Step 17:

The server constructs an adjustment prompt sentence based on the emotional state, inventory status, meal condition data, and delivery schedule information.

The server embeds context, such as “stressed user” or “limited time,” into textual instructions that request simplified or modified recipes.

Input: The estimated emotional state, inventory dataset, meal condition data, and delivery schedule information.

Output: An adjustment prompt sentence configured to direct the generative AI model to modify the cooking procedure or ingredient usage.

The server ensures that the adjustment prompt sentence references the existing recipe steps or ingredient lists to maintain logical continuity.

### Step 18:

The server sends the adjustment prompt sentence to the generative AI model and receives adjusted cooking content.

The server invokes the same or a related generative AI model with modified parameters if necessary, such as reduced maximum length or different temperature.

Input: The adjustment prompt sentence.

Output: Adjustment result data including updated step descriptions, simplified instructions, or alternative ingredient suggestions.

The server merges this adjustment result data with the original structured recipe representation to form an updated recipe adapted to the user's emotional state and context.

### Step 19:

The server creates explanation prompt sentences for improving clarity of individual cooking steps.

The server extracts each step description and constructs textual instructions requesting clearer, beginner-friendly explanations.

Input: The step descriptions from the structured recipe representation and, optionally, the adjustment result data.

Output: One or more explanation prompt sentences, each corresponding to a set of steps or an entire recipe.

The server sends these explanation prompt sentences to the generative AI model and receives explanation data with refined descriptions and hints.

### Step 20:

The server integrates the explanation data, adjustment result data, inventory status, order status, and delivery schedule information into unified presentation data.

The server builds a hierarchical data object that associates recipe titles, ingredient availability, step-by-step instructions, and live order information.

Input: The explanation data, adjustment result data, inventory dataset, order identifiers, and delivery schedule information.

Output: Integrated presentation information ready for display or audio rendering.

The server transmits this integrated presentation information to the terminal as a response to a client request, enabling the terminal to present a coherent, context-aware cooking guide to the user.

It is also possible to incorporate an emotion engine for estimating the user's emotions.

That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional cooking support systems and electronic commerce systems generally treat image recognition, recipe suggestion, ingredient ordering, and user guidance as independent functions executed by loosely coupled software components. In such systems, image analysis of storage apparatus contents, generation of cooking procedures, determination of missing items, and arrangement of delivery are not orchestrated by a unified computational flow. As a result, multiple data transformations, heterogeneous interfaces, and manual user interventions are required, which increase latency, consume excessive computing resources, and frequently break the continuity of the user experience.

Further, known systems typically rely on static rule-based engines or pre-defined recipe databases. These approaches are not well-suited to dynamically combining real-time storage state, flexible user meal preferences, and variable delivery constraints. They also lack a robust mechanism for transforming heterogeneous user inputs (e.g., free-form natural language, voice, and selection operations) into standardized machine-usable data that can be used to control downstream automated processes. Consequently, the computing resources of the server and the portable terminal are not efficiently utilized, and the system cannot automatically and reliably adapt to variations in available items, user constraints, or service conditions.

Additionally, in conventional architectures, generative models, if used at all, are typically invoked in an ad hoc manner, without a structured prompt design that systematically encodes both the detected item information and normalized user preferences. There is no consistent pipeline where outputs of a generative model are programmatically parsed, compared against structured storage information, and then fed back into the generative model with refined prompt sentences to obtain machine-usable, stepwise instructions. This leads to inconsistent responses, increased error rates in identifying missing ingredients, and difficulty in integrating generative outputs into transactional processes such as electronic commerce order placement.

Moreover, existing systems generally do not leverage user state data (such as voice tone, facial expression, and body motion) as a computational signal to adapt cooking content, complexity, and timing. Without algorithmic use of inferred user emotions as an input to prompt generation and adjustment logic, the system cannot optimize the interaction flow or adaptively control the use of generative models based on the user's real-time state. This reduces the efficiency of user guidance, can result in user frustration, and fails to exploit feedback mechanisms that could improve the performance of the overall computing process.

Therefore, there is a need for an improved computer-implemented system and processing flow that tightly integrates: (i) image-based item recognition on server-side computing resources; (ii) normalization of user meal preferences using natural language processing; (iii) structured prompt sentence generation for a generative artificial intelligence model; (iv) automatic extraction of missing items and integration with an electronic commerce interface including delivery time scheduling; (v) re-invocation of the generative model to obtain reformatted, stepwise cooking procedures; and (vi) adaptive adjustment of instructions and orders based on user emotional state. Such a system should reduce manual intervention, minimize redundant processing, and improve the technical performance of the underlying computing infrastructure by orchestrating these components in a unified, machine-optimized workflow.

The specific processing by the specific processing unit 290 of the data processing device 12 in Example 2 is realized by the following means.

The present invention provides a server comprising a processor and a memory storing instructions that, when executed by the processor, cause the server to perform a unified sequence of operations including: receiving, from a portable terminal, image data representing an interior of a storage apparatus; performing image preprocessing and inference using a machine learning model on the image data to generate structured item information including at least an item type, quantity, and validity period; receiving heterogeneous user input and converting the user input into standardized text data representing a meal preference using a natural language processing algorithm; constructing a structured prompt sentence that embeds the item information and the standardized text data and supplying the structured prompt sentence to a generative artificial intelligence model to obtain machine-readable cooking instruction data and cooking procedure data; programmatically comparing required item information extracted from the cooking instruction data with the structured item information to identify shortage items, generating order data for an electronic commerce platform including delivery time information calculated based on a scheduled homecoming time of a user, and transmitting the order data via an application programming interface; generating further prompt sentences for the generative artificial intelligence model to obtain reformatted, stepwise explanation text suitable for presentation on the portable terminal; acquiring user state data, estimating an emotional state using a machine learning model, and generating adjustment parameters based on the emotional state, the item information, and the cooking instruction data to update at least one of the cooking instruction data, the cooking procedure data, and the order data through additional invocations of the generative artificial intelligence model; and generating guidance data including updated cooking procedure data and delivery time information for interactive presentation on the portable terminal. This enables an integrated computer-centric workflow that reduces redundant data transformations, improves the efficiency and determinism of interactions between perception models, generative models, and transactional services, and dynamically adapts the generation and presentation of cooking-related content based on both current storage conditions and inferred user state, thereby improving overall system performance and user interaction quality in a technically grounded manner.

The term “processor” refers to a hardware processing unit or a combination of hardware processing units, such as a central processing unit or a graphics processing unit, that executes instructions to perform computational operations.

The term “memory” refers to a non-transitory computer-readable storage medium, such as semiconductor memory, magnetic storage, or optical storage, that stores instructions and data for execution by a processor.

The term “portable terminal” refers to a portable electronic apparatus, such as a smartphone, tablet, or wearable device, that includes at least a communication interface, a display apparatus, and an input apparatus, and that is operable by a user.

The term “image acquisition apparatus” refers to an imaging hardware component, such as a camera module or optical sensor, included in or connected to a portable terminal and configured to capture image data.

The term “storage apparatus” refers to a physical storage structure, such as a refrigerator, freezer, pantry, or cabinet, in which items including foodstuffs or consumable goods are stored.

The term “image data” refers to digital data representing visual information, such as pixel data in a still image or video frame, acquired by an image acquisition apparatus.

The term “communication path” refers to a logical or physical communication link, such as a wired or wireless network connection, through which data is transmitted between a portable terminal and a server.

The term “server” refers to a computing apparatus or a group of cooperating computing apparatuses configured to provide processing, storage, and communication services to one or more portable terminals via a network.

The term “image preprocessing” refers to computational operations applied to raw image data, such as resizing, normalization, noise reduction, color space conversion, or cropping, in order to prepare the image data for further processing or inference.

The term “machine learning model” refers to a parameterized computational model trained using data, such as a neural network, decision tree, or ensemble model, that performs tasks including classification, detection, recognition, or regression based on input data.

The term “inference processing” refers to execution of a trained machine learning model on input data to produce output data such as predicted labels, probabilities, bounding boxes, or other estimated values.

The term “structured item information” refers to data organized in a predetermined format, such as a record or table, indicating at least an item type, a quantity, and a validity period for one or more items stored in a storage apparatus.

The term “item type” refers to a category or classification of an item, such as a kind of foodstuff or product class, represented by a generalized name or identifier.

The term “quantity” refers to numerical or categorical information indicating an amount of an item, such as a count, weight, volume, or portion size.

The term “validity period” refers to a time-related attribute of an item, such as an expiration date, best-before date, or recommended consumption period.

The term “user input” refers to information provided by a user via an input apparatus, including but not limited to voice input, text input, and selection input.

The term “voice input” refers to audio data representing spoken utterances of a user, acquired by an audio input apparatus such as a microphone.

The term “text input” refers to character data entered by a user, for example via a keyboard, touch panel, or handwriting recognition interface.

The term “selection input” refers to data indicating a user choice among presented options, such as a menu selection, button press, or list item selection.

The term “natural language processing algorithm” refers to a computational procedure configured to analyze and transform natural language text, including operations such as tokenization, parsing, semantic analysis, normalization, or intent recognition.

The term “standardized text data” refers to text data that has been transformed into a normalized representation according to predefined rules or formats, suitable for consistent processing by downstream components.

The term “meal preference” refers to information representing a desired meal condition of a user, including at least one of cuisine type, main ingredient preference, dietary restriction, cooking time constraint, or taste preference.

The term “prompt sentence” refers to a textual input sequence, including one or more sentences or structured segments, provided as input to a generative artificial intelligence model to guide generation of an output.

The term “generative artificial intelligence model” refers to a computational model, such as a generative language model or generative neural network, trained to produce new data including text, images, or other content based on input data.

The term “cooking instruction data” refers to data representing requirements or high-level directives for preparing one or more dishes, including at least required item information and possibly cooking methods or constraints.

The term “cooking procedure data” refers to data representing a series of ordered steps or actions for preparing a dish, including operations to be performed, sequence information, time information, and optionally temperature information.

The term “required item information” refers to data indicating items and associated quantities that are needed to execute a cooking procedure or prepare a dish.

The term “shortage item” refers to an item that is required according to required item information but is absent from, or present in insufficient quantity in, the structured item information representing stored items.

The term “merchandise information” refers to data identifying a product available for purchase, such as a product category, product identifier, price information, or packaging unit.

The term “electronic commerce platform” refers to a network-based transaction system that provides services for listing, ordering, and purchasing goods or services through electronic communication.

The term “application programming interface” refers to a defined interface, including at least one endpoint, request format, and response format, that allows software components to interact programmatically.

The term “order data” refers to structured data representing a purchase order, including at least merchandise information, quantity information, user identification information, and delivery-related information.

The term “scheduled homecoming time” refers to time-related information indicating a predicted or designated time at which a user is expected to be at a location such as a home or delivery address.

The term “delivery time information” refers to data indicating a time or time interval during which delivery of ordered items is scheduled or requested.

The term “explanation text” refers to text data that describes a cooking step or operation in a manner suitable for human understanding, including instructions, notes, and clarifying information.

The term “user interface” refers to a logical or physical interface, including graphical, audio, or tactile elements, that enables interaction between a user and a computing apparatus.

The term “user state data” refers to data acquired from one or more sensors or input apparatuses that reflects a condition or behavior of a user, including at least one of uttered voice, facial image, and body motion.

The term “emotional state” refers to an inferred internal state of a user, such as stress level, satisfaction, frustration, or calmness, estimated based on user state data.

The term “adjustment parameter” refers to data representing one or more modification rules, weights, or values used to change at least one of cooking content, item selection, cooking difficulty, cooking time, or order content.

The term “guidance data” refers to data prepared for presentation to a user, including at least cooking procedure data, explanation text, and delivery time information, arranged for interactive cooking assistance.

The term “interactive cooking assistance presentation” refers to a mode of operation in which a portable terminal presents cooking-related information stepwise and responds to user operations or progress by updating displayed or output content.

In one embodiment, a server cooperates with a terminal operated by a user to implement a cooking support and ingredient management system. The server includes at least one processor, a main memory, a non-transitory storage device, a network interface, and optionally one or more graphics processing units. The terminal includes at least a processor, a memory, a communication interface, a display apparatus, an audio input apparatus, and an image acquisition apparatus such as an integrated camera module.

The terminal executes an application program that is stored in the memory of the terminal. The terminal uses an operating system, such as a mobile operating system, to access hardware components. The terminal controls the image acquisition apparatus through a camera framework of the operating system, acquires digital image data representing the interior of a storage apparatus, and encodes the image data using an imaging library into a compressed format such as a JPEG file. The terminal constructs a network request including the encoded image file and transmits the network request to the server via a wireless network using a secure protocol.

The server receives the network request at the network interface and stores the image data into the non-transitory storage device. The server uses an image processing library such as a numerical array library and a computer vision library to perform image preprocessing. The server resizes the image to a fixed resolution, normalizes pixel values to a predefined range, and converts the image into a tensor structure. The tensor structure is a multi-dimensional array in which dimensions correspond to batch size, height, width, and color channels. The server stores a pointer to the tensor in main memory and forwards the tensor to a machine learning module.

The server loads a machine learning model into memory. In one embodiment, the server uses a convolutional neural network implemented in a machine learning framework such as TensorFlow or PyTorch. The model architecture may include multiple convolutional layers with rectified linear unit activation functions, batch normalization layers, pooling layers, and fully connected layers. The server configures the model to output, for each input image, a set of predicted object classes and associated bounding boxes and confidence scores. The server trained this model in advance on a dataset of labeled images of food items and storage apparatus interiors. During training, the server used a supervised learning algorithm with a loss function defined as a combination of a classification loss (such as cross-entropy) and a localization loss (such as smooth L1). The server applied stochastic gradient descent or an adaptive optimization method such as Adam to update model weights. The server used data augmentation techniques including random cropping, rotation, brightness adjustment, and flipping to improve generalization.

At runtime, the server performs inference by executing the forward pass of the convolutional neural network on the tensor generated from the image data. The server uses a graphics processing unit for accelerating matrix multiplications and convolution operations. The server obtains predictions for each candidate object region. The server then executes a non-maximum suppression algorithm to remove overlapping bounding boxes based on confidence scores. The server converts the remaining detections into structured item information. The structured item information is represented as a record including, for each detected item, an item type encoded as a generalized label (for example “fish”, “leafy vegetable”, “dairy product”), a quantity value (for example number of packages or approximate weight), and a validity period (for example an estimated expiration date inferred from detected label text or a default shelf-life for the item type).

The server optionally executes an optical character recognition engine on sub-images corresponding to labels detected on packages. The server uses segmentation and binarization algorithms to isolate label regions and a recognition model, such as a recurrent neural network or transformer encoder trained on character sequences, to convert image patches into text strings.

The server parses the text strings to identify date patterns and standardized date formats, and then converts them into validity period values. The server stores the structured item information in a database system, such as a relational database, with a schema including item identifier fields, item type fields, quantity fields, and validity period fields indexed by a user identifier.

The terminal acquires user input via multiple input modalities. The user provides a meal preference using at least one of voice input through a microphone, text input through a software keyboard, and selection input through selectable elements on the display. The terminal performs local preprocessing, such as audio sampling and encoding for voice input or character encoding normalization for text input. The terminal transmits the user input to the server as structured data.

The server receives the user input and passes voice data to an automatic speech recognition module. The automatic speech recognition module may be implemented using an acoustic model such as a deep neural network and a language model such as a recurrent or transformer-based model. The server converts the audio features (for example Mel-frequency cepstral coefficients) into a text transcript. The server then processes all user input text with a natural language processing algorithm. In one embodiment, the server uses a sequence labeling model or intent classification model to map free-form text into standardized text data representing meal preferences. The server segmentizes the text into tokens, applies part-of-speech tagging, and identifies entities such as cuisine types, cooking time constraints, ingredient preferences, and dietary restrictions. The server encodes the meal preference into a normalized key-value structure, for example fields such as “cuisine=Japanese”, “main_ingredient=fish”, “max_cook_time=40 minutes”.

The server then constructs a prompt sentence to be consumed by a generative AI model. The server concatenates a natural language description of the structured item information and the standardized text data into a textual sequence. The server may use a template such as:
“Refrigerator contents: [list of items with generalized names].
User preference: [normalized meal preference text].
Task: Propose several recipe ideas that use these ingredients as much as possible. For each recipe, list the required ingredients and indicate which ones are missing from the given refrigerator contents. Then generate clear, step-by-step cooking instructions that a beginner can follow.”

The server may append additional constraints, such as output format or maximum number of recipes. The server uses this combination of structured representation and template-based formatting to reduce ambiguity and to create a deterministic mapping from internal data structures to the generative AI model input.

The server communicates with a generative AI model hosted on a remote computing resource. The generative AI model is a large-scale autoregressive language model with a transformer architecture. The model comprises multiple attention layers, each including self-attention heads, layer normalization, and feed-forward sublayers. The model is trained on text corpora using a next-token prediction objective. During inference, the server tokenizes the prompt sentence using a subword tokenizer, sends the token sequence to the generative AI model through an application programming interface, and receives an output token sequence representing generated text. The server decodes the output tokens into a text string.

The server parses the generated text using deterministic rules. The server expects section headers and numbering as indicated in the prompt. The server splits the text into recipe entries and further into required ingredient lists and stepwise instructions. The server converts each required ingredient entry into a normalized representation with an ingredient type and quantity. The server cross-references the ingredient types with the structured item information stored in the database.

The server uses an algorithm that matches generalized category labels and applies mapping tables for synonymous terms. The server then evaluates quantity sufficiency by comparing the required amount with available quantities. If an item is absent or insufficient, the server marks it as a shortage item and adds it to a shortage list data structure.

The server uses the shortage list to prepare merchandise information for an electronic commerce platform. The server maintains a mapping between generalized item types and product identifiers in a product catalog. The server selects appropriate products by applying rules that consider packaging size, unit price, and expiration dates. The server constructs order data including user identifier, delivery address, product identifiers, quantities, and requested delivery time information. The server calculates the delivery time information based on a scheduled homecoming time associated with the user profile or provided by the user. The server computes a time window by subtracting a buffer time from the scheduled homecoming time and classes it to the platform's time slot scheme.

The server transmits the order data to the electronic commerce platform through a defined application programming interface. The server handles authentication tokens, retries failed transmissions, and parses responses containing confirmation numbers and estimated delivery times. The server records these values in the database and associates them with the current cooking session.

The server then refines the cooking procedure data for presentation. In one embodiment, the server issues another prompt sentence to the generative AI model, embedding previously generated cooking instructions and specifying a strict output format. An example of such a prompt sentence is:
“Given the following recipe instructions:
[previous instructions text]
Reformat these instructions into a numbered list of concise steps. Each step should contain: (1) a short action description, (2) an approximate duration in minutes, and (3) any temperature setting if applicable. Output only the list of steps in the specified format.”

The server again uses a template that constrains output structure. This non-conventional usage pattern of a generative AI model, where the same model is invoked sequentially with progressively more structured prompts, improves determinism of outputs and aligns raw natural language generation with the strict data structures needed by the system. The server parses the returned text into step entities, each including a step index, a description field, a duration field, and an optional temperature field, and stores these as cooking procedure data in the database.

The server acquires user state data to further adapt the cooking session. The terminal captures user voice data through the microphone, facial images through the camera, and body motion data through motion sensors such as accelerometers or gyroscopes. The terminal transmits these data streams to the server under user consent conditions. The server extracts features from each modality: for audio, the server computes pitch, energy, and spectral features; for images, the server detects facial landmarks and expressions using a convolutional network; for motion data, the server computes movement intensity and periodicity. The server inputs these features into an emotion estimation model, such as a multi-layer perceptron or a multimodal fusion network trained to output an emotional state label or a continuous emotional score.

The server uses the estimated emotional state as a control signal to adjust cooking-related data. For example, if the user is inferred to be stressed or in a hurry, the server may reduce the number of steps by merging granular instructions, prioritize faster recipes, or suggest simplified substitutions. If the user appears relaxed and engaged, the server may retain more detailed instructions or suggest additional side dishes. The server encodes these modifications as adjustment parameters, such as a target complexity level, a maximum per-step duration, or a threshold for optional steps. The server constructs another prompt sentence incorporating these parameters and sends it to the generative AI model to obtain a revised set of instructions or adjusted ingredient recommendations. This iterative prompt-based adjustment process goes beyond human-style manual editing and constitutes a specialized algorithmic flow that leverages multi-modal user signals to control model behavior in a reproducible manner.

The terminal receives guidance data from the server, including the updated cooking procedure data, explanation text for each step, and delivery time information for ordered items. The terminal renders an interactive interface in which each step is displayed individually with clear text and optional iconography. The terminal starts local timers corresponding to step durations and uses notification mechanisms to inform the user when a timed operation is complete. The terminal can also display alerts when ordered items are about to arrive based on the delivery time information. The terminal thereby coordinates physical actions in the real world (such as placing food into an oven or receiving a delivery) with digital guidance generated and managed by the server.

From a technical perspective, the described configuration and processing flow improve computer technology in several ways. The server reduces end-to-end latency and network load by using structured item information and standardized text data as compact intermediate representations, which require less bandwidth than raw images or unstructured natural language exchanges for downstream processing. The deterministic prompt sentence templates and explicit parsing rules decrease variance in generative model outputs, leading to more predictable computational behavior and reducing the need for manual correction. The server's use of GPU-accelerated convolutional networks and transformer-based generative models in a coordinated, pipeline manner optimizes resource utilization by batching inference requests and reusing model sessions. The integration of emotion estimation as a computational control signal allows the server to dynamically adjust the complexity and content of instructions in a way that reduces user error rates and minimizes unnecessary back-and-forth interactions, thereby decreasing server-side processing cycles and network traffic. The use of multimodal features and specialized fusion networks for emotion inference distinguishes the system from simple rule-based or purely manual adaptation. Additionally, the system's ability to automatically translate detected shortages into structured order data aligned with an external application programming interface, and to schedule delivery based on computed time windows, reduces the complexity of client-side logic and centralizes coordination in the server, improving maintainability and extensibility of the software architecture.

Alternative embodiments are also possible. The server may use different neural network architectures, such as a vision transformer for item recognition or a recurrent neural network for emotion estimation. The server may employ different optimization algorithms and loss functions during training, such as focal loss for handling imbalanced detection tasks or contrastive loss for improving representation quality. The server may store structured item information in different data structures, such as key-value stores or document-oriented databases, provided that the item type, quantity, and validity period are represented in a queryable format. The generative AI model may run locally on the server instead of a remote service, as long as the server receives a prompt sentence and returns generated text.

In another embodiment, the terminal may execute some inference tasks locally, such as preliminary item recognition or emotion estimation, and send only compressed features or intermediate results to the server. This variation can reduce communication load and enable faster feedback. In yet another embodiment, the server may maintain multiple generative AI models tuned for different languages or culinary domains, and select an appropriate model based on user profile data and historical preferences.

In all embodiments, the server, the terminal, and the user cooperate through the described data structures, algorithms, and neural network configurations to implement a non-trivial computational pipeline. This pipeline is not a mere automation of human steps, but rather applies machine learning models, structured prompt design, and iterative refinement to achieve higher accuracy in ingredient detection, greater consistency in recipe generation, reduced communication overhead, and improved adaptability to user state, thereby enhancing the technical performance of the underlying computer system.

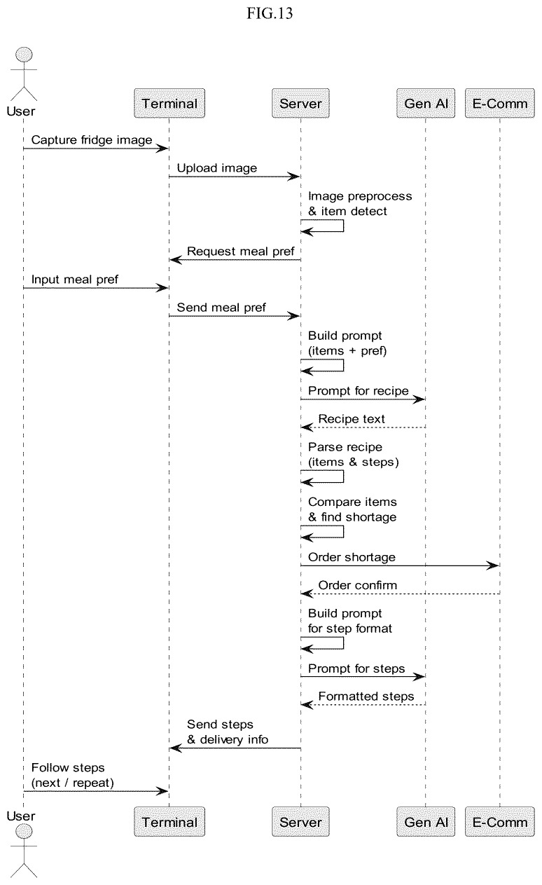

The following describes the processing flow using FIG. 13.

### Step 1:

The user operates the terminal to capture an image of the interior of a storage apparatus. The terminal activates the image acquisition apparatus through an operating system camera API, displays a preview on the display, and, when the user presses a capture control, acquires raw image sensor data. The terminal encodes the raw data into a compressed image format such as JPEG and associates metadata including user identifier and timestamp.

Input: analog light signals from the storage apparatus interior and user operation events on the terminal.

Output: digital image data representing the storage apparatus interior, stored as a compressed image file and a metadata structure in the terminal memory.

### Step 2:

The terminal transmits the captured image data to the server. The terminal constructs a network request message including the compressed image file and metadata as a multipart or binary payload and sends the message via a wireless network using a secure protocol. The terminal handles connection setup, retry if transmission fails, and acknowledgment from the server.

Input: compressed image file and associated metadata in the terminal memory.

Output: a network data packet stream delivered to the server, containing the image data and metadata.

### Step 3:

The server receives and stores the image data. The server's network interface accepts the incoming data stream, and a web application module reconstructs the HTTP request and extracts the image payload and metadata. The server writes the image file to a non-transitory storage device and registers a database record linking the stored file path with the user identifier and timestamp.

Input: network data packets containing the image payload and metadata.

Output: a stored image file on the server storage and a database entry referencing the stored image and the associated user.

### Step 4:

The server performs image preprocessing to generate a tensor for inference. The server reads the stored image file from storage into main memory, then uses an image processing library to decode the compressed data into pixel arrays. The server resizes the image to a fixed resolution, normalizes pixel values into a predetermined numeric range, and arranges the pixel data into a multi-dimensional tensor structure with predefined dimensions.

Input: compressed image file read from server storage.

Output: a preprocessed image tensor stored in main memory, ready for input to a machine learning model.

### Step 5:

The server executes an item recognition inference using a convolutional neural network. The server loads model parameters from storage into memory and, if available, into GPU memory. The server forwards the image tensor to the convolutional neural network, which applies convolution operations, non-linear activations, and pooling operations layer by layer to extract hierarchical visual features. The final network layers compute class logits and bounding box coordinates. The server then applies a non-maximum suppression algorithm to the model outputs to remove redundant overlapping detections and keeps only bounding boxes with confidence scores above a threshold.

Input: preprocessed image tensor and trained convolutional neural network parameters.

Output: a set of detected items, each containing at least a generalized item type label, bounding box coordinates, and a confidence score.

### Step 6:

The server constructs structured item information from the detection results. The server groups detections with similar labels and overlapping regions to count quantities of the same item type. The server optionally applies heuristics or look-up tables to convert counts and bounding box areas into approximate quantities, such as units or weight estimates. The server creates a structured record for each item type, including generalized type, quantity, and an initial validity period placeholder.

Input: set of detected items with labels, bounding boxes, and confidence scores.

Output: structured item information records representing item types and quantities in the storage apparatus.

### Step 7:

The server optionally executes optical character recognition to determine validity periods. The server identifies label regions on packages using bounding box coordinates and crops corresponding sub-images. The server binarizes and cleans the sub-images, then passes them to an optical character recognition engine, which converts visual characters into text strings. The server parses the text strings for date patterns and converts recognized dates into a standardized date format. The server assigns the derived validity periods to the corresponding structured item information records.

Input: cropped label sub-images derived from detection bounding boxes.

Output: structured item information records updated with validity period values.

### Step 8:

The terminal acquires the user's meal preference and transmits it to the server. The user inputs preferences by speaking to the microphone, typing on a software keyboard, or selecting options from graphical controls. The terminal converts voice signals into audio samples, or text into encoded strings, and packages the preference data with a user identifier. The terminal sends this data via a network request to the server.

Input: user voice signals, typed characters, and selection events on the terminal.

Output: a network request containing meal preference data in digital form transmitted to the server.

### Step 9:

The server normalizes the user's meal preference into standardized text data. The server receives the meal preference data and, if voice data is present, passes it through an automatic speech recognition module to produce a text transcript. The server tokenizes the text, performs part-of-speech tagging, and applies an intent and entity recognition model to extract structured attributes such as cuisine type, desired main ingredient, dietary restrictions, and maximum cooking time. The server maps these attributes into a normalized representation, such as key-value pairs, and stores them as standardized text data.

Input: meal preference data including audio samples and/or raw text sent from the terminal.

Output: standardized text data representing the user's meal preference in a structured, normalized format.

### Step 10:

The server generates a first prompt sentence for a generative AI model using the item information and standardized text data. The server retrieves the latest structured item information for the user from the database and converts each record into generalized textual descriptions. The server inserts these descriptions and the standardized meal preference text into a template that specifies a task and an expected output structure. The server concatenates these parts into a single, well-formed prompt sentence or multi-line prompt.

Input: structured item information records and standardized text data for the meal preference.

Output: a first prompt sentence that embeds storage contents and user preferences in a constrained natural language format.

### Step 11:

The server invokes the generative AI model with the first prompt sentence and receives generated recipe content. The server tokenizes the prompt sentence according to the model's tokenizer, encapsulates the tokens in a request structure, and sends the request to the generative AI model via an application programming interface. The generative AI model computes attention-based transformations layer by layer over the token sequence, predicts successive tokens according to learned probability distributions, and stops generation upon reaching a termination condition. The server receives the resulting token sequence, decodes it into a text string, and stores the raw generated content.

Input: first prompt sentence provided as a tokenized text sequence.

Output: generated recipe content as a text string, including proposed recipes, required ingredients, and preliminary cooking instructions.

### Step 12:

The server parses the generated recipe content into cooking instruction data and cooking procedure data. The server applies rule-based parsers that locate headings, numbered lists, and ingredient sections as indicated in the prompt specification. The server extracts, for each recipe, a list of required items with quantities and a list of sequential actions. The server converts the required items into a structured format with normalized item types and quantities and converts each action into an ordered step description.

Input: generated recipe content as a free-form text string.

Output: structured cooking instruction data containing required item information and structured cooking procedure data containing ordered step descriptions.

### Step 13:

The server determines shortage items by comparing required item information with structured item information. The server iterates over each required item entry and searches for a matching item type in the structured item information records. The server uses mapping tables to resolve synonyms and category-level equivalences. For each match, the server compares the required quantity with the available quantity and marks any deficit. The server collects all unmatched or insufficient items into a shortage list structure.

Input: required item information extracted from cooking instruction data and stored structured item information.

Output: a shortage list containing shortage item entries with item types and missing quantities.

### Step 14:

The server generates order data for an electronic commerce platform and schedules delivery. The server maps each shortage item type to one or more product identifiers using a product catalog maintained on the server. The server selects appropriate products using criteria such as package size and price. The server retrieves the user's delivery address and scheduled homecoming time from a user profile. The server computes a delivery time window by applying an offset to the scheduled homecoming time. The server constructs order data including product identifiers, quantities, address information, and delivery time information, and sends this as a request to the electronic commerce platform via an application programming interface.

Input: shortage list, product catalog, and user profile containing address and scheduled homecoming time.

Output: structured order data transmitted to the electronic commerce platform and confirmation data including order identifiers and delivery estimates stored on the server.

### Step 15:

The server generates a second prompt sentence to refine cooking procedure data into stepwise explanation text. The server selects the cooking procedure data corresponding to one or more recommended recipes and converts each step into textual form. The server then embeds these texts into a template that instructs the generative AI model to reformat the instructions into numbered, concise steps with explicit durations and temperatures. The server builds a second prompt sentence such as:
“Refrigerator contents: salmon, spinach, onions.
User preference: I want to eat Japanese food, using fish as the main ingredient, and I prefer dishes that can be cooked in under 40 minutes.
Task: Propose several recipe ideas that use these ingredients as much as possible. For each recipe, list the required ingredients and indicate which ones are missing from the given refrigerator contents. Then generate clear, step-by-step cooking instructions that a beginner can follow.”
or, for reformatting previously generated content:
“Given the following recipe instructions:
[previous instructions text]
Reformat these instructions into a numbered list of concise steps. Each step should contain: (1) a short action description, (2) an approximate duration in minutes, and (3) any temperature setting if applicable. Output only the list of steps in the specified format.”

Input: structured cooking procedure data and optionally previously generated instructions text.

Output: a second prompt sentence designed to elicit structured, stepwise explanation text from the generative AI model.

### Step 16:

The server invokes the generative AI model with the second prompt sentence and constructs final explanation text data. The server sends the tokenized second prompt to the generative AI model through the application programming interface and receives generated text representing reformatted instructions. The server parses the numbered list of steps into individual step records and extracts duration and temperature annotations. The server assigns each record a step index and stores these as explanation text data linked to the underlying cooking procedure data.

Input: second prompt sentence.

Output: explanation text data comprising numbered step descriptions with associated durations and temperatures.

### Step 17:

The terminal and the server cooperate to acquire user state data. The terminal records user voice signals during interaction, captures facial images through the camera, and samples motion sensor signals reflecting body movements. The terminal packages these sensor readings, timestamps, and user identifiers, and transmits them to the server. The server receives the sensor data and performs feature extraction, computing audio features, facial expression features, and motion features.

Input: raw sensor data from microphone, camera, and motion sensors on the terminal.

Output: feature vectors representing user state characteristics stored in server memory.

### Step 18:

The server estimates the user's emotional state and determines adjustment parameters. The server inputs the extracted feature vectors into an emotion estimation model previously trained on labeled emotional data. The model outputs a discrete emotional label or continuous emotional scores. The server evaluates these outputs against thresholds and rules to decide whether the user appears stressed, neutral, or relaxed. The server then selects adjustment parameters, such as target difficulty level, maximum number of steps, or total allowed cooking time, based on the emotional state.

Input: feature vectors representing user state characteristics.

Output: estimated emotional state values and corresponding adjustment parameters for modifying cooking instructions and order content.

### Step 19:

The server generates a third prompt sentence that encodes the adjustment parameters and updates cooking-related data using the generative AI model. The server incorporates the original cooking instruction data, the adjustment parameters, and context explanations into a new prompt sentence, instructing the generative AI model to simplify, elaborate, or otherwise adjust the recipes. The server sends this third prompt to the generative AI model, receives adjusted instructions, and then replaces or augments existing cooking instruction data and cooking procedure data with the adjusted versions.

Input: original cooking instruction data, adjustment parameters, and context information.

Output: updated cooking instruction data and cooking procedure data that reflect modifications based on the user's emotional state.

### Step 20:

The server assembles guidance data and transmits it to the terminal. The server collects the updated cooking procedure data, explanation text data, and delivery time information associated with the current cooking session. The server formats these into a structured response message and sends the message to the terminal via the network interface. The response contains ordered steps, textual explanations, and indicators for expected arrival times of ordered items.

Input: updated cooking procedure data, explanation text data, and delivery time information stored on the server.

Output: guidance data message transmitted to the terminal for interactive presentation.

### Step 21:

The terminal presents interactive cooking assistance to the user based on the guidance data. The terminal parses the received guidance data, generates user interface screens that display one step at a time, and shows explanation text and timing information. The terminal starts local countdown timers for steps with specified durations and updates visual progress indicators as time elapses. The terminal responds to user input events such as “next step” or “repeat instruction” by advancing the current step index or replaying the explanation text, and may issue notifications when deliveries are imminent according to the delivery time information.

Input: guidance data received from the server and user interaction events on the terminal.

Output: dynamic screen updates, audio or visual notifications, and an interactive cooking assistance experience synchronized with the physical cooking process.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-assisted recipe and shopping systems typically treat each technical component in isolation: image capture modules only store images, recognition engines merely return labels, natural language interfaces only convert user text to keywords, and recommendation engines output generic recipes. As a result, such systems suffer from several technical limitations.

First, existing systems generally lack an integrated, machine-executable workflow that turns raw multimodal sensor data (camera images, microphone audio, user interface events) into a structured, context-aware cooking procedure. Image data of a storage apparatus, such as a refrigerator, is usually processed separately from user preference data, and there is no unified data model that consistently links recognized items, standardized meal preferences, and generated recipes. This fragmented processing causes repeated parsing, ad-hoc data transformations, and redundant calls to external services, thereby increasing latency, network load, and processor utilization on both client and server devices.

Second, conventional systems typically rely on fixed, rule-based logic to propose recipes and shopping lists, which makes it difficult to adapt the system behavior dynamically to constraints that are only known at runtime, such as the current state of the storage apparatus, fine-grained user preferences, and the user's emotional state. In particular, when a user is tired or stressed, the system has no robust mechanism to automatically simplify the cooking procedure, shorten the cooking time, or adjust the level of explanation, so the resulting output may be technically correct but practically unusable. This leads to inefficient use of computation and I/O resources, because complex recipes and explanations are generated, transmitted, and rendered even when a simplified variant would better match the user's current context.

Third, existing architectures rarely treat large-scale generative models as controllable components within a deterministic pipeline. Prompt sentences, when used, are often hard-coded and not systematically derived from structured state. This prevents the system from leveraging generative models as flexible “sub-processors” that can be programmatically steered by machine-generated prompts reflecting recognized items, normalized user preferences, and inferred emotion. As a consequence, the generative models tend to behave as black boxes that must be post-processed extensively, adding more computational overhead and introducing latency and inconsistency.

Fourth, conventional systems do not provide an integrated, computer-implemented control flow that closes the loop between recognized storage contents, generated recipes, and automated ordering via electronic transaction services. The determination of lacking ingredients, order scheduling, and presentation of adjusted instructions is often left to manual user operations or separate applications, resulting in redundant network transactions, duplicated parsing logic, and state desynchronization between inventory management, recipe generation, and ordering subsystems.

Therefore, there is a need for an improved computer-implemented system that (i) unifies image analysis, natural language processing, generative model interaction, and emotion estimation into a single, coherent processing pipeline, (ii) treats prompt sentence generation as a first-class, programmable step that conditions the behavior of generative models, (iii) automatically computes lacking ingredients and cooperatively controls an electronic transaction interface, and (iv) dynamically adjusts the complexity, content, and presentation of cooking procedures based on estimated user emotion, thereby improving overall system responsiveness, resource utilization, and user suitability at the level of the underlying computing architecture.

The specific processing by the specific processing unit 290 of the data processing device 12 in Application Example 2 is realized by the following means.

The present invention provides a server comprising a processor configured to (i) control an image acquisition unit of a portable information processing apparatus of a user to acquire an image of a storage apparatus and to store the acquired image as digital data, (ii) analyze the acquired image data by applying an image processing algorithm and a machine learning model to identify food items in the storage apparatus, specify attribute information of the food items including at least a name, a quantity, and deadline information, and store the attribute information as structured data in a storage unit, (iii) acquire a meal preference of the user based on voice input, character input, or selection input from the user, convert the meal preference into standardized meal preference data by using a natural language processing algorithm, and store the standardized meal preference data, (iv) generate a first prompt sentence that programmatically encodes the attribute information and the standardized meal preference data in a form suitable for conditioning a generative information processing model, provide input data including the first prompt sentence to the generative information processing model, and obtain cooking procedure data generated by the generative information processing model based on the first prompt sentence, (v) analyze the cooking procedure data, compare required ingredient information included in the cooking procedure data with the attribute information of the food items in the storage apparatus to specify lacking ingredients, and generate and transmit, through a communication interface, order request data including order information and delivery time information for the lacking ingredients to an electronic transaction service so as to order the lacking ingredients and set a delivery time, (vi) generate a second prompt sentence for instructing the generative information processing model to generate explanatory text of the cooking procedure for each process included in the cooking procedure data, provide the second prompt sentence to the generative information processing model to obtain explanatory text data for visual presentation or audio presentation, and transmit the explanatory text data to the portable information processing apparatus, (vii) acquire multimodal emotion-related data including at least one of voice tone data, expression data, and body motion data of the user, apply an emotion estimation machine learning model to the emotion-related data to estimate emotion information representing an emotional state of the user, and store the emotion information, (viii) determine adjustment conditions for changing at least one of content of the cooking procedure, selection of ingredients, difficulty of cooking, cooking time, or content of ingredient ordering based on the emotion information and the cooking procedure data, generate a third prompt sentence for instructing the generative information processing model to perform adjustment of the cooking procedure data and ingredient information based on the emotion information, provide the third prompt sentence to the generative information processing model, and obtain adjusted cooking procedure data and adjusted ingredient information from the generative information processing model, and (ix) generate presentation information by changing at least one of a level of detail, a number of processes, or an expression format of at least one of the adjusted cooking procedure data and the explanatory text data according to the emotion information, and transmit the presentation information to the portable information processing apparatus. This enables a tightly integrated, computer-implemented pipeline in which sensor-derived state of a storage apparatus, normalized user preference data, and machine-estimated emotion information are fused into machine-generated prompt sentences that deterministically steer generative models, thereby reducing redundant computations and network interactions, improving consistency between inventory data, recipe data, and ordering data, and dynamically adapting the complexity and presentation of generated cooking procedures to the user's current context, which results in improved performance and usability at the level of the underlying computing system.

The term “processor” refers to a hardware or software controlled computing unit, such as a central processing unit, a microcontroller, or a processing core of an information processing apparatus, that executes stored instructions to perform data acquisition, analysis, generation, and control operations described in the present disclosure.

The term “portable information processing apparatus” refers to a mobile computing device possessed by a user, such as a smartphone, a tablet terminal, or a handheld computer, that includes at least an image acquisition unit, a sound acquisition unit, a display unit, a communication interface, and optionally a sound output unit.

The term “image acquisition unit” refers to an image sensing component of the portable information processing apparatus, such as a digital camera module or an image sensor, that captures an image of a physical space, including an interior of a storage apparatus, and outputs corresponding image data as digital data.

The term “sound acquisition unit” refers to an acoustic sensing component of the portable information processing apparatus, such as a microphone or an array of microphones, that acquires audio signals including user speech and outputs corresponding audio data as digital data.

The term “storage apparatus” refers to a physical container or equipment used to store items, such as a refrigerator, a freezer, a pantry, or another storage device, in which food items or other stored objects are arranged and from which image data is acquired.

The term “image data” refers to digital data representing at least one image captured by the image acquisition unit, for example pixel data encoded in a format such as JPEG, PNG, or another image representation.

The term “digital data” refers to information represented in an electronic format suitable for processing by a computing device, including but not limited to image data, audio data, text data, structured data, and control data.

The term “image processing algorithm” refers to a sequence of computational procedures applied to image data, including operations such as resizing, filtering, segmentation, feature extraction, or object detection, for the purpose of facilitating identification of items depicted in the image.

The term “machine learning model” refers to a computational model trained on sample data to perform tasks such as classification, detection, recognition, or regression, including but not limited to neural networks, decision tree ensembles, and other statistical models, and that is applied to input data to infer outputs such as identified food items or estimated emotion information.

The term “food item” refers to any consumable item stored in the storage apparatus, including ingredients, prepared meals, or packaged food products, that may be identified from image data and used in a cooking procedure.

The term “attribute information” refers to information describing properties of a food item, including at least a name of the item, a quantity of the item, and deadline information representing a recommended date or time by which the item should be consumed.

The term “deadline information” refers to temporal information associated with a food item, such as an expiration date, a best-before date, or another time-related indicator that specifies or approximates a recommended consumption period.

The term “structured data” refers to data organized according to a predefined schema or data model, such as records, fields, and keys in a database, that allows consistent storage, retrieval, and processing of information such as attribute information and standardized meal preference data.

The term “meal preference” refers to information indicating a user's desired conditions for a meal, including but not limited to cuisine type, main ingredient, cooking time, number of servings, dietary restrictions, taste preferences, or other constraints expressed by the user.

The term “standardized meal preference data” refers to meal preference information that has been converted from free-form user input into a normalized representation according to predefined categories, formats, or schemas, such that the data can be programmatically processed and combined with other structured data.

The term “natural language processing algorithm” refers to a computational procedure that analyzes and transforms human language input, for example tokenization, morphological analysis, entity extraction, or intent classification, to derive structured information from text or transcribed speech.

The term “generative information processing model” refers to a model, such as a generative artificial intelligence model, that receives input data including at least one prompt sentence and automatically generates output data such as text describing a cooking procedure, explanatory text, or adjusted ingredient information.

The term “prompt sentence” refers to a machine-generated or human-generated natural language instruction or query provided as part of the input to the generative information processing model, the prompt sentence encoding structured context such as attribute information, standardized meal preference data, or emotion information for conditioning the behavior of the generative information processing model.

The term “cooking procedure data” refers to output data generated by the generative information processing model that describes a sequence of processes for preparing one or more dishes, including step-by-step instructions, required ingredients, and optionally time, temperature, or other operational parameters.

The term “required ingredient information” refers to information contained in the cooking procedure data that describes ingredients needed to execute the cooking procedure, including identifiers of the ingredients and associated quantities or units.

The term “lacking ingredients” refers to ingredients that are required according to the required ingredient information but are not available, or are insufficiently available, in the storage apparatus as determined by comparing the required ingredient information with the attribute information.

The term “electronic transaction service” refers to a remote commerce system accessible via a communication network, such as an online shopping service or a network-based supermarket service, that receives order request data and performs ordering and delivery scheduling for items.

The term “communication interface” refers to a hardware and software interface that enables data exchange between the processor and an external system, such as a network interface, an application programming interface, or a communication protocol endpoint.

The term “order request data” refers to structured data transmitted to an electronic transaction service, the order request data including at least information identifying items to be ordered, quantities, delivery destination information, and delivery time information.

The term “delivery time information” refers to information indicating a desired or scheduled time period for delivery of ordered items, such as a specific time of day, a time window, or a date, used by the electronic transaction service to schedule delivery.

The term “explanatory text data” refers to text generated for presenting explanations of a cooking procedure, including step-by-step descriptions, additional tips, or clarifications, intended for display or audio output to the user.

The term “visual presentation” refers to presentation of information by using a display unit, such as displaying text, images, or graphical elements on a screen of the portable information processing apparatus.

The term “audio presentation” refers to presentation of information by using a sound output unit, such as playing synthesized speech or sounds through a speaker of the portable information processing apparatus.

The term “voice tone data” refers to acoustic features derived from user speech, including pitch, volume, tempo, intonation, or spectral characteristics, that are used as input to an emotion estimation machine learning model.

The term “expression data” refers to visual information related to a user's facial appearance or expressions, obtained from image data or video data, and used as input to estimate an emotional state.

The term “body motion data” refers to information about movements or postures of a user's body, derived from sensors or image analysis, that can be used to infer the user's emotional state.

The term “emotion estimation machine learning model” refers to a machine learning model that receives emotion-related data, such as voice tone data, expression data, or body motion data, and outputs emotion information representing a predicted emotional state of the user.

The term “emotion information” refers to data representing an estimated emotional state of a user, such as “tired,” “happy,” “stressed,” or “neutral,” optionally including a confidence value or other metadata.

The term “adjustment conditions” refers to rules, parameters, or criteria determined based on emotion information and cooking procedure data, which specify how at least one of content of the cooking procedure, selection of ingredients, difficulty of cooking, cooking time, or content of ingredient ordering should be modified.

The term “adjusted cooking procedure data” refers to cooking procedure data that has been modified by the generative information processing model according to adjustment conditions based on emotion information, for example to simplify steps, reduce cooking time, or change ingredient selection.

The term “adjusted ingredient information” refers to ingredient-related information output from the generative information processing model after adjustment based on emotion information, including modifications to ingredient types, quantities, or ordering details.

The term “presentation information” refers to information for output to the user, derived from at least one of the adjusted cooking procedure data and the explanatory text data, whose level of detail, number of processes, or expression format has been changed according to the emotion information.

The term “display unit” refers to a component of the portable information processing apparatus that visually presents information to the user, such as a liquid crystal display or an organic light emitting display.

The term “sound output unit” refers to a component of the portable information processing apparatus that outputs sound to the user, such as a speaker, an earphone, or another audio transducer.

The term “database” refers to a structured data storage system, such as a relational database or a non-relational data store, that maintains records for attribute information, standardized meal preference data, emotion information, cooking procedure data, and other data described in the present disclosure.

In one embodiment, a server, a terminal, and a storage apparatus cooperate to implement the claimed system. The server includes at least one processor, a main memory, a non-volatile storage unit, and a network interface. The terminal includes a processor, a memory, an image acquisition unit (camera), a sound acquisition unit (microphone), a display unit, a sound output unit, and a wireless or wired communication interface. The storage apparatus is, for example, a household refrigerator or another container whose interior can be imaged.

The server executes a software stack that includes: an operating system (for example, a general-purpose server operating system), a web application framework, an image processing library such as OpenCV or Pillow, a machine learning framework such as TensorFlow or PyTorch, a natural language processing library, a generative AI model runtime, and an application-specific control program. The terminal executes a mobile operating system (for example, a smartphone OS) and a dedicated application that controls the image acquisition unit and the sound acquisition unit, and that communicates with the server via an application-level protocol over HTTP or HTTPS.

The server maintains several specific data structures in a database. The server stores refrigerator inventory as item records, each record including fields such as item_id, item_name, quantity_value, quantity_unit, deadline_date, and location_id. The server stores standardized meal preferences as preference records, each record including fields such as cuisine_category, time_limit_minutes, serving_count, restricted_ingredients, desired_style, and a reference to a user_id. The server stores emotion information as emotion records, including fields such as emotion_label, confidence_score, and a timestamp. The server stores cooking procedure data as recipe records and step records, where a recipe record includes a recipe_id, title_text, and metadata, and each step record includes a step_id, recipe_id, step_index, instruction_text, and optional attributes such as estimated_time_seconds and heat_level. The server stores order information as order records, each including fields such as order_id, item_list, delivery_time_window, and order_status.

The server uses the image processing library to convert raw camera frames obtained from the terminal into normalized image tensors. The server uses a convolutional neural network object detection model, such as a model based on a YOLO-type architecture or a Faster-R-CNN-type architecture, to detect bounding boxes and class probabilities for food items in the storage apparatus. The server, in one implementation, configures the neural network with multiple convolutional layers, batch normalization layers, nonlinear activation functions such as rectified linear units, and feature pyramid structures for multi-scale detection. The server pre-trains this model on a dataset of labeled refrigerator images and then fine-tunes the model on domain-specific data containing packaged food and household ingredients.

The server uses the machine learning framework to define and train this object detection model. The server defines a loss function that combines classification loss (for example, cross-entropy loss over item categories) and localization loss (for example, a smooth L1 loss over bounding box coordinates). The server uses a gradient-based optimization algorithm, such as stochastic gradient descent with momentum or an adaptive method, to update the weights of the network. The server augments training images using techniques such as random cropping, random brightness variation, and random horizontal flipping, to increase generalization to various lighting and placement conditions. Because the server executes this trained model, the server can infer, from each image, item labels with associated confidence scores and bounding boxes.

The server further applies an optical character recognition algorithm, for example using a recurrent neural network-based OCR engine, to image patches around detected packages. The server extracts textual information such as product names and dates and parses strings that match date patterns to estimate deadline information. The server maps product names to normalized item names via a dictionary and a fuzzy matching algorithm. As a result, the server generates structured attribute information for each detected food item, including a canonical name, a quantity, and deadline information, and stores the structured data in the item records. This structured representation directly supports efficient indexing and query operations and reduces repeated parsing of raw text when later computing lacking ingredients.

The terminal acquires a meal preference from the user using a graphical interface and optionally voice input. The terminal, when the user speaks, sends audio data to the server or executes an on-device speech recognition model. When the server receives transcribed text, the server uses a natural language processing algorithm to tokenize and analyze the text. For example, the server applies morphological analysis and part-of-speech tagging to extract cuisine-related terms, time constraints expressed in natural language, and references to main ingredients. The server maps extracted terms to controlled vocabularies, such as a predefined list of cuisine_category values and ingredient categories, and the server fills the fields of a preference record. In this way, the server converts free-form language into standardized meal preference data that can be efficiently combined with inventory data and that can be embedded into prompt sentences.

The server estimates emotion information of the user using multimodal data. The terminal sends voice tone data and expression data to the server. The server computes acoustic feature vectors from the audio, including pitch contours, intensity measures, speaking rate, and spectral features such as mel-frequency cepstral coefficients. The server computes facial feature embeddings from expression data using a convolutional neural network trained for facial expression recognition. The server feeds these features into an emotion estimation machine learning model, such as a neural network with fully connected layers, that has been trained to predict discrete emotion labels and confidence scores. The server trains this model on paired data of recorded user signals and ground-truth annotations of emotional state, and the server uses a loss function such as cross-entropy across emotion classes. The server updates the model parameters with gradient descent, similarly to the object detection model. Because the server fuses features from audio and image modalities, the server achieves higher accuracy and robustness than a single-modality estimator, which directly improves the reliability of subsequent emotion-dependent adjustments.

The server uses generative AI models to generate cooking procedures and explanations. In one embodiment, the server uses a transformer-based language model stored as a generative information processing model. The server maintains a prompt construction module that assembles prompt sentences from structured state. The server obtains the current item records, the standardized meal preference record, and the emotion record from the database. The server then concatenates these values into a natural-language prompt sentence according to a predefined template. An example prompt sentence used by the server for a tired user is:
“You are a professional home-cooking assistant.
The user is tired today and wants an easy meal.
The refrigerator currently contains:
Eggs: 4
Tomatoes: 2
Milk: 1 bottle
The user wants Japanese-style food and prefers to cook in under 15 minutes, for 2 servings.
Please propose exactly one simple Japanese recipe using mainly these ingredients.
1) Output a recipe title.
2) Output a list of ingredients with quantities.
3) Output a step-by-step cooking procedure in simple sentences.
4) Output a list of missing ingredients that are necessary to make the dish.
Keep the instructions concise and suitable for a tired user.”

The server sends this prompt sentence as input to the generative AI model via a programmatic interface. The server runs the generative AI model on a processing unit configured with sufficient memory, and the server obtains cooking procedure data in response. The server parses the response by recognizing headings such as “Ingredients” and “Steps” and by splitting lines into fields. Because the server uses structured prompt templates that directly encode the normalized inventory and preference records, the server reduces the need to perform ad hoc semantic interpretation of arbitrary text, which decreases parsing complexity and improves the determinism of the pipeline.

The server similarly generates a second prompt sentence to obtain explanatory text for each step, for example:
“Please rewrite the following cooking steps so that a beginner can easily follow them.
Use simple language, mention approximate cooking times, and specify heat levels (low, medium, high).
Steps:
1. Slice the onion thinly.
2. Cut potatoes and beef into bite-size pieces.
3. Heat oil in a pot and fry the onion.
4. Add potatoes and beef and fry.
5. Add water and simmer for 15 minutes.
6. Add curry roux and simmer for 10 more minutes.”

The server uses the second prompt sentence to obtain explanatory text data that improves clarity for inexperienced users. Additionally, the server constructs a third prompt sentence when emotion-based adjustment is required, for example:
“The following recipe is for curry.
The user's emotion is ‘tired’.
Please simplify this recipe to make it as easy as possible while keeping it tasty.
Reduce the number of steps, remove advanced techniques, and ensure the total cooking time is less than 20 minutes.
Original recipe steps:
1. Slice the onion thinly (full list).
Output a new list of simplified steps.”

The server then obtains adjusted cooking procedure data from the generative AI model. The server compares the original and adjusted procedures to compute changes in step count and estimated time. The server stores both versions and selects an appropriate level of detail based on the emotion record.

The server uses the cooking procedure data to compute lacking ingredients. The server compares required ingredient information extracted from the generated recipe with the structured attribute information in the item records. The server uses item_name fields and quantity_value fields to perform arithmetic comparisons and to build a list of lacking ingredients that must be ordered.

The server uses a product mapping table to convert lacking ingredients into product identifiers recognized by an electronic transaction service. The server assembles order request data containing product identifiers, desired quantities, and delivery time information based on user-specific preferences. The server transmits this order request data via a network interface to the transaction service's communications endpoint. Once the server receives a confirmation, the server logs order_id and delivery_time_window in the order records. This tight integration between recipe generation and ordering removes redundant user operations and centralizes state in the server, thereby reducing synchronization errors and unnecessary network calls.

The terminal receives recipe data, explanatory text data, and presentation information from the server. The terminal renders the recipe title and ingredient list on the display unit and presents a step-by-step interface. The terminal uses a text-to-speech engine to convert explanatory text into audio signals that are output through the sound output unit. The terminal may adapt font size and layout based on metadata included in the presentation information, such as instructions to simplify or enlarge text for a tired user. Because the server has already adjusted the content to match the emotional state and capabilities of the user, the terminal can present appropriate guidance without performing complex on-device reasoning, thereby reducing terminal-side processing load and battery consumption.

The system as implemented provides technical improvements beyond mere automation of human tasks. The server uses specific data structures and a controlled prompt construction process to treat generative AI models as programmable components rather than opaque text generators. By encoding inventory and preference state into structured records and then into prompt sentences, the server eliminates redundant parsing and reduces the number of model calls required to converge on a usable recipe and explanation. The server's coordinated execution of neural network-based detection, OCR, NLP, and emotion estimation results in improved accuracy and consistency of recognized items and emotional state, which then leads to more efficient generation of recipes and more accurate determination of lacking ingredients. Because the server performs emotion-based adjustment of cooking procedures at the data structure level, the server avoids transmitting excessively complex instructions when simplified instructions are sufficient, which reduces data transfer size and decreases latency.

Moreover, the server's use of pre-trained and fine-tuned neural network architectures for object detection and emotion estimation, with explicitly defined loss functions and training procedures, results in models that outperform rule-based detection and simple heuristics. These models can robustly recognize partially occluded items, noisy labels, and subtle emotional cues, allowing the server to maintain accurate, up-to-date inventory and emotion records even in imperfect sensing conditions. This improves the correctness of subsequent computations, reduces the need for manual correction, and lowers the error rate in automated ordering. Because the server centralizes and coordinates these models with an explicit control flow, the overall computing system operates with reduced total computation time and communication overhead compared to a collection of independent services.

In an alternative embodiment, the server deploys the generative AI model on specialized hardware such as a graphics processing unit or a tensor processing unit to accelerate generation of cooking procedure data and explanatory text data. The server caches previously generated recipes indexed by combinations of item inventory and meal preference data. When the server determines that a new request is similar to a cached scenario, the server reuses or lightly modifies cached recipes instead of issuing a full generative request, which reduces inference load and network traffic to external model providers. This caching mechanism is integrated with the structured data model so that the server can quickly match queries, further improving system throughput.

In another embodiment, the terminal runs a lightweight variant of the emotion estimation model locally for basic detection of coarse emotion categories, and the server refines the estimation using more complex models. In this configuration, the terminal can perform immediate adaptation of presentation layout (for example, dimming or enlarging text) even before the server finishes its full emotion analysis, thus improving responsiveness while still relying on the server's more precise estimation for content-level adjustments.

In yet another embodiment, the server generates prompt sentences in multiple languages depending on user preference, and the server stores language-specific templates for prompt construction. Because the server operates on standardized meal preference data and normalized inventory fields, the server can switch languages by replacing only the template text while reusing the same underlying structured values, which demonstrates that the architectural improvement resides in the data model and prompt orchestration rather than in language-specific heuristics.

Across these embodiments, the server, the terminal, and the storage apparatus form a coordinated computing system that integrates sensing, structured data modeling, neural network inference, generative AI model conditioning via prompt sentences, and downstream control of transaction and presentation components. The described configuration and interactions improve processing speed, recognition accuracy, data management efficiency, and user-appropriate presentation in a manner that depends on the specific technical architecture and algorithms, rather than on generic human substitution, thus enabling practical implementation of the claimed system.

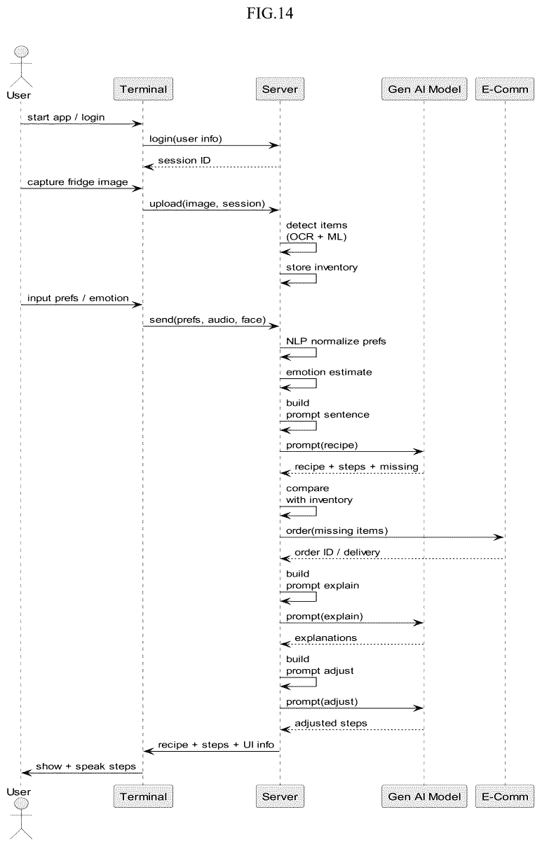

The following describes the processing flow using FIG. 14.

### Step 1:

The user operates the terminal to start a dedicated application and authenticate.

Input: user interaction (touch events, credentials).

Output: an active application session identifier stored on the terminal and on the server.

The terminal sends a login request including user credentials and device information to the server. The server validates the credentials against a user database, generates a session ID, associates the session ID with the user ID, and returns the session ID to the terminal. Based on the received session ID, the terminal initializes in-memory structures for later image, preference, and emotion data.

### Step 2:

The user operates the terminal to capture an image of the interior of a storage apparatus.

Input: user tap on a “scan” button and live camera sensor data.

Output: a compressed image file representing the storage apparatus interior.

The terminal controls the image acquisition unit using an operating system camera API, displays a live preview, and when the user taps a capture control, the terminal acquires a frame from the camera sensor. The terminal encodes the raw frame into a JPEG or PNG file, applies local resizing and compression to reduce resolution and file size, and stores the image temporarily in device memory with a reference to the active session ID.

### Step 3:

The terminal transmits the captured image to the server.

Input: the compressed image file and the session ID.

Output: a server-side stored image object and a database record referencing it.

The terminal creates an HTTP or HTTPS POST request with multipart/form-data containing the image file and the session ID and sends it via the communication interface. The server receives the request, validates the file type and size, saves the image into a storage unit (for example, as a binary object with a generated object key), and writes a database record linking the session ID to the object key and a status flag “pending recognition.”

### Step 4:

The server performs image preprocessing on the stored image.

Input: the stored image object.

Output: a normalized image tensor or array suitable for machine learning inference.

The server loads the image from storage, uses an image processing library to decode it into a pixel matrix, converts color space if necessary (for example, from RGB to BGR), resizes the image to a fixed resolution expected by the detection model, and applies normalization such as mean subtraction and scaling. The server outputs a multidimensional array that becomes an input to the object detection model.

### Step 5:

The server executes an object detection model to identify food items in the image.

Input: the normalized image tensor.

Output: a list of detected objects with class labels, confidence scores, and bounding boxes.

The server feeds the image tensor into a convolutional neural network that has been trained for object detection. The server performs forward propagation through convolution, pooling, and fully-connected layers to compute feature maps and classification logits. The server applies a softmax function to obtain class probabilities and calculates bounding box coordinates using regression heads. The server then applies non-maximum suppression to remove overlapping detections and outputs a list of detected items, each represented by a class label, a confidence score, and a bounding box.

### Step 6:

The server performs optical character recognition on relevant regions of the image.

Input: the original image and bounding boxes near package labels.

Output: textual strings corresponding to product names and date information.

The server crops image regions around the bounding boxes that likely contain text, converts these regions to grayscale if necessary, and enhances contrast. The server passes each region through an OCR engine, which decodes character sequences from pixel patterns. The server aggregates character sequences into text strings and identifies substrings that correspond to product names and date formats.

### Step 7:

The server derives structured attribute information for each food item.

Input: detected object labels with bounding boxes and OCR text strings.

Output: a structured list of item records including item names, quantities, and deadline information.

The server maps each detected label to a canonical item name using a lookup table and string similarity algorithms. The server estimates quantity by counting detection instances or by interpreting units from OCR text. The server parses date substrings using date pattern matching to determine deadline information. The server composes an item record for each unique item, populating fields such as name, quantity_value, quantity_unit, and deadline_date, and stores these records in a database table associated with the session ID.

### Step 8:

The user operates the terminal to input meal preferences.

Input: user text entry, menu selections, and optionally voice input.

Output: raw preference expressions transmitted to the server.

The terminal displays input elements such as text boxes, dropdown lists, and toggle buttons. The user may type “I want Japanese food with fish in less than 20 minutes” or may select a cuisine category and time limit. If the user uses voice input, the terminal records audio and converts it to text via speech recognition. The terminal aggregates the text, selection values, and the session ID, and sends this preference payload to the server over HTTPS.

### Step 9:

The server normalizes the user's meal preference into standardized data.

Input: raw preference text and selection values.

Output: a standardized meal preference record with controlled-category fields.

The server applies a natural language processing algorithm to tokenize the input text, performs part-of-speech tagging, and extracts entities corresponding to cuisine types, time constraints, ingredient mentions, and dietary restrictions. The server then maps each extracted term to standardized categories, such as mapping “Japanese food” to “Japanese” in a cuisine_category field and interpreting “less than 20 minutes” as time_limit_minutes=20. The server merges this information with any explicit selection values from the UI, stores the result in a preference record, and links it to the session ID.

### Step 10:

The terminal acquires emotion-related signals from the user.

Input: user consent, voice signals, and facial images.

Output: audio clips and image frames transmitted to the server.

The terminal requests permission to access the microphone and front camera. When authorized, and when the user interacts (for example, saying “I feel tired today” facing the screen), the terminal records a short audio segment and captures one or more image frames. The terminal tags these signals with timestamps and the session ID and sends them to the server via HTTPS.

### Step 11:

The server estimates the user's emotional state from multimodal data.

Input: audio clips and facial image frames.

Output: an emotion label and confidence score stored in an emotion record.

The server extracts acoustic features from the audio by computing pitch, energy, speaking rate, and spectral coefficients. The server extracts facial features from the images using a convolutional neural network that outputs an embedding vector representing facial expression.

The server concatenates or otherwise fuses these feature vectors and feeds them into an emotion estimation neural network that has been trained to classify emotions. By performing a forward pass and applying a softmax over emotion classes, the server outputs probabilities for labels such as “tired,” “happy,” or “neutral.” The server selects the label with the highest probability as the emotion label, records the label and confidence score in the emotion record, and associates it with the session.

### Step 12:

The server constructs a primary prompt sentence for a generative AI model using structured state.

Input: item records, standardized meal preference record, and emotion record.

Output: a primary prompt sentence in natural language.

The server reads the inventory item list, the standardized preference fields, and the emotion label from the database. The server uses a template that specifies sections such as “available ingredients,” “user preference,” and “emotion context.” The server inserts the canonical item names and quantities, the cuisine_category and time_limit_minutes, and a textual description of the emotion (for example, “The user is tired today”). The server concatenates these elements into a coherent natural-language prompt sentence that instructs the generative AI model to generate a recipe and cooking procedure.

### Step 13:

The server calls the generative AI model to generate cooking procedure data.

Input: the primary prompt sentence.

Output: cooking procedure data including a recipe title, ingredient list, and step-by-step instructions.

The server sends the primary prompt sentence as input to the generative AI model through a programmatic interface. The generative AI model processes the sequence of tokens and outputs a response text. The server receives the response text and parses it using pattern matching and structural markers, such as headings “Ingredients” and “Steps,” to extract a recipe title, a list of ingredients with quantities, and a numbered list of steps. The server stores these elements as a recipe record and associated step records linked to the session.

### Step 14:

The server determines lacking ingredients by comparing recipe requirements with inventory.

Input: required ingredient information from the cooking procedure data and item records from the inventory.

Output: a list of lacking ingredients with required quantities.

The server iterates through the recipe ingredient list, and for each required item, searches the inventory table for a matching canonical name. When the server finds a match, the server compares the required quantity with the available quantity. If the available quantity is insufficient or if no match exists, the server records the ingredient in a lacking ingredient list, with the difference between required and available quantities. The server outputs this list as structured data for ordering.

### Step 15:

The server generates and transmits order request data to an electronic transaction service.

Input: the lacking ingredient list and user delivery preferences.

Output: order request data and an order ID with a scheduled delivery time.

The server maps each lacking ingredient to a product identifier from a product catalog. The server composes an order payload that includes product identifiers, quantities, the user's delivery address, and a desired delivery time window, for example based on the user's usual return-home time. The server sends this payload to an electronic transaction service via a communication interface. Upon receiving a response, the server extracts the order ID and confirmed delivery time, stores them in an order record, and associates them with the session.

### Step 16:

The server constructs a secondary prompt sentence to obtain explanatory text for each step.

Input: the step records of the cooking procedure data.

Output: a secondary prompt sentence in natural language.

The server concatenates the numbered steps into a single text block and inserts it into an explanatory template, which instructs the generative AI model to rewrite the steps for clarity, including approximate times and heat levels. The server creates a prompt such as “Please rewrite the following cooking steps so that a beginner can easily follow them” followed by the raw steps.

The server outputs this secondary prompt sentence for further generation.

### Step 17:

The server obtains explanatory text data from the generative AI model.

Input: the secondary prompt sentence.

Output: refined explanatory text per cooking step.

The server sends the secondary prompt sentence to the generative AI model and receives a response containing elaborated instructions. The server parses the response and maps each refined instruction back to the corresponding step index. The server updates the step records with new instruction_text values and optional fields for estimated_time_seconds and heat_level. The server stores these updates in the database.

### Step 18:

The server constructs a tertiary prompt sentence for emotion-based adjustment.

Input: the original cooking procedure data and the emotion record.

Output: a tertiary prompt sentence specifying adjustment conditions.

The server reads the emotion_label (for example, “tired”) and examines the current number of steps and estimated total time. The server decides adjustment conditions, such as reducing the number of steps and limiting total time below a threshold. The server builds a tertiary prompt sentence that states the user's emotion, specifies required simplification or enrichment, and appends the original steps. The server outputs this tertiary prompt sentence for use with the generative AI model.

### Step 19:

The server generates adjusted cooking procedure data based on emotion.

Input: the tertiary prompt sentence.

Output: adjusted cooking procedure data with modified steps and possibly modified ingredient requirements.

The server sends the tertiary prompt sentence to the generative AI model and obtains a revised set of steps and, in some cases, adjusted ingredient recommendations. The server parses the result into a new set of step records and possibly a new ingredient list. The server computes differences between original and adjusted procedures and updates the active recipe version for the session to the adjusted one. The server stores both original and adjusted versions for reference.

### Step 20:

The server generates presentation information tailored to the user's emotional state.

Input: adjusted cooking procedure data, explanatory text data, and the emotion record.

Output: presentation information including layout hints and selection of content.

The server uses the emotion_label to decide the level of detail and pacing of the instructions. For a “tired” user, the server selects only the simplified steps and shorter explanations and may specify larger font sizes and slower speech rate. The server composes a presentation package that includes the recipe title, the final ingredient list, the ordered and adjusted steps, and metadata for layout and audio parameters. The server sends this package to the terminal.

### Step 21:

The terminal presents the recipe and guides the user through cooking.

Input: the presentation information from the server.

Output: visual and audio guidance displayed and played to the user.

The terminal parses the presentation package, displays the recipe title and ingredients on the display unit, and shows one step at a time according to the step order. When the user starts cooking, the terminal uses a text-to-speech engine to synthesize audio from the step instructions, applying parameters such as speech rate derived from the presentation metadata. The terminal waits for user input (for example, tapping “Next”) or voice commands to advance to subsequent steps. The user follows the displayed and spoken instructions to complete the dish.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

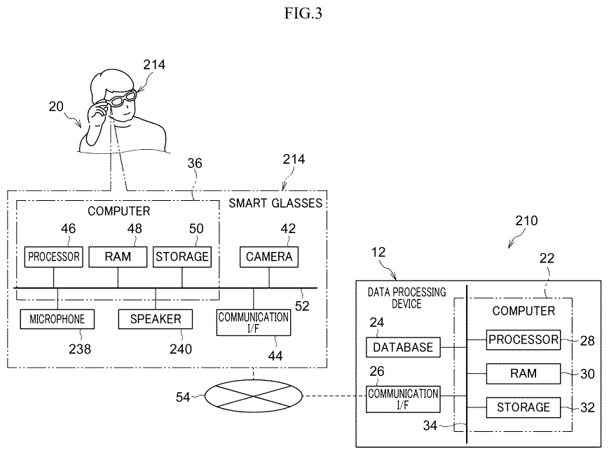

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

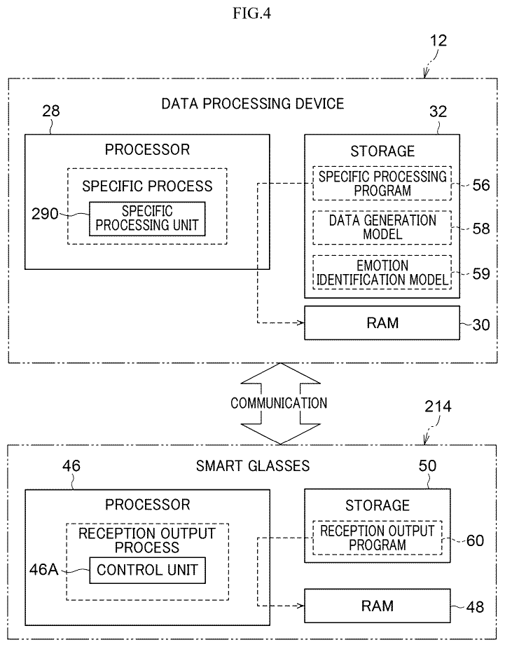

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc.

The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

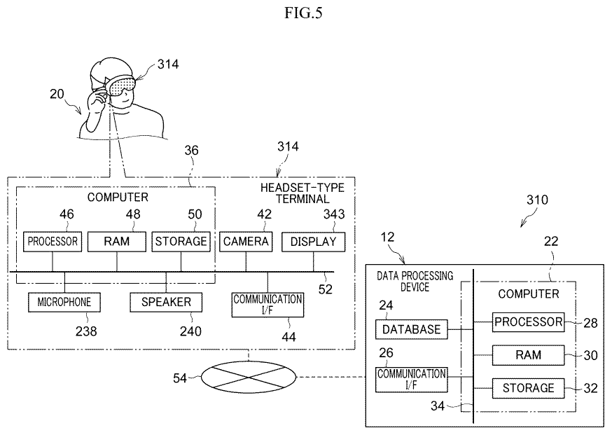

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication i/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

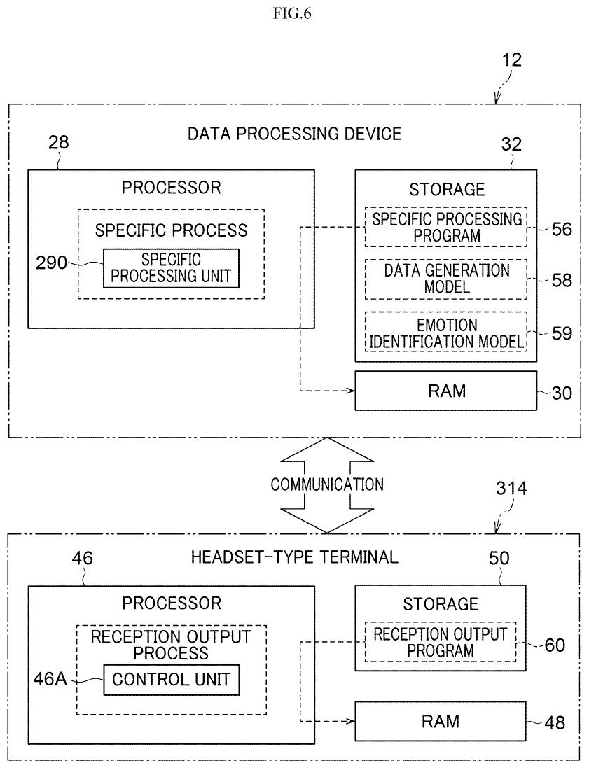

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

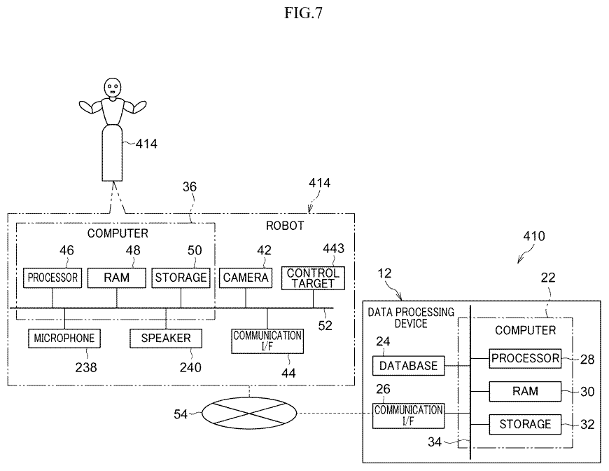

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

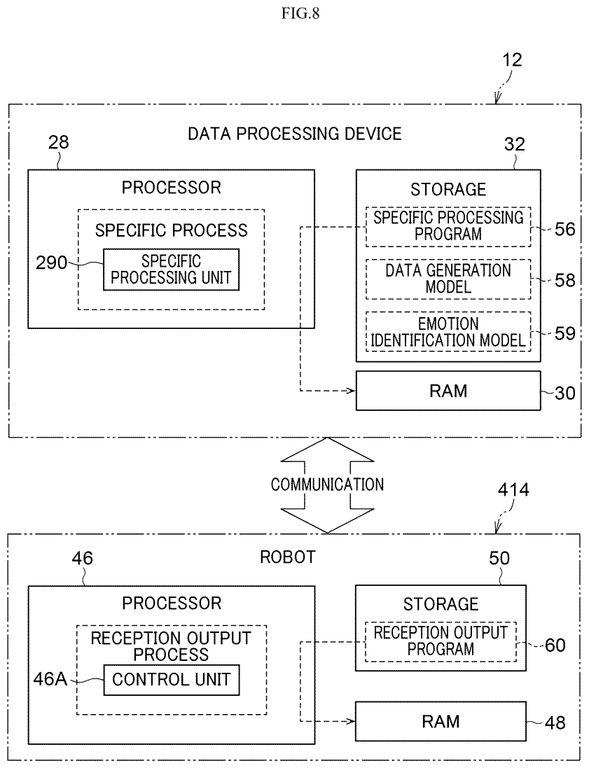

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

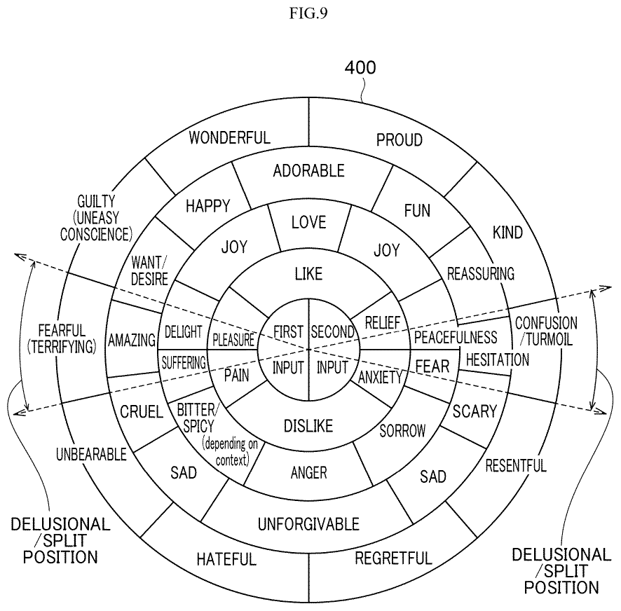

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

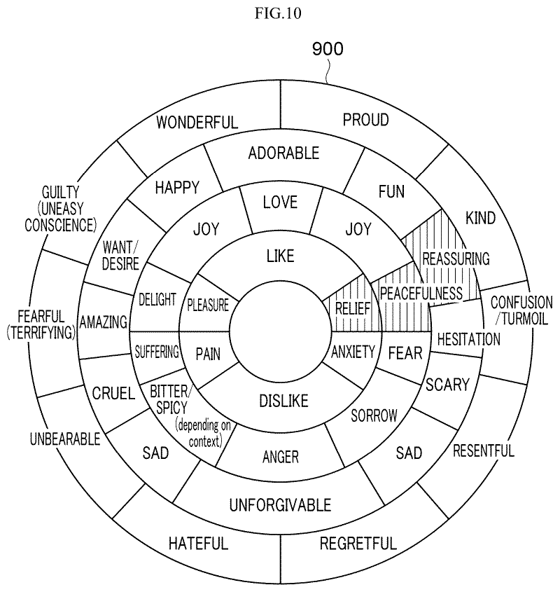

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
control an imaging unit of a portable information terminal of a user to acquire image data of an interior of a storage apparatus, store the image data in the portable information terminal, and transmit the stored image data to a server via a communication network,
execute, in the server, preprocessing and object recognition processing on the acquired image data by using an image processing program and a machine learning model, and generate item list data representing articles stored in the storage apparatus as abstract category information including type information and quantity information of the articles,
acquire preference information of the user by the portable information terminal through at least one of voice input, text input, and selection input, analyze the preference information by a natural language processing program to convert the preference information into standardized preference data representing at least one of a meal type, a number of persons, a cooking time, and preference conditions, and transmit the standardized preference data to the server,
generate, in the server, a prompt sentence for input to a generative AI model by using the item list data and the standardized preference data, provide the prompt sentence to the generative AI model, and cause the generative AI model to generate cooking procedure data including recipe information and step information,
analyze, in the server, ingredient requirement information included in the generated cooking procedure data, compare the ingredient requirement information with the item list data to extract candidate insufficient ingredients, associate the candidate insufficient ingredients with product category information, transmit the candidate insufficient ingredients to an application programming interface of an electronic commerce platform, and generate and transmit order data including delivery destination information and desired delivery time information so as to perform ordering and delivery time setting of the candidate insufficient ingredients,
extract, in the server, for each step of the generated cooking procedure data, step structure data including contents of the step, a required time, and ingredients to be used, provide a presentation prompt sentence to the generative AI model by using the step structure data as input, cause the generative AI model to generate description data for visual or auditory presentation, and transmit the description data to the portable information terminal,
receive, in the portable information terminal, the description data, sequentially present the description data stepwise on a user interface by at least one of display output and audio output, update progress status of the steps in response to an operation input of the user, and transmit progress status data to the server,
acquire, in at least one of the portable information terminal and an external sensor, behavior data representing at least one of a voice signal, a facial image, and a body motion signal of the user, and transmit the behavior data to the server,
and apply, in the server, a machine learning model to the behavior data to estimate an emotional state of the user, generate an adjustment prompt sentence for changing at least one of contents of the cooking procedure, types of ingredients, cooking difficulty, cooking time, and ordering contents of ingredients on the basis of the emotional state, the item list data, and the standardized preference data, provide the adjustment prompt sentence to the generative AI model to cause the generative AI model to generate adjustment result data, and update at least one of the cooking procedure data and the order data on the basis of the adjustment result data.

### (Supplementary 2)

The system according to supplementary 1,
wherein the processor is configured to
generate, in the server, the prompt sentence for the generative AI model by including text data obtained by integrating the item list data detected in the storage apparatus, the standardized preference data of the user, past cooking history data, and at least one of product inventory information and deliverable time information acquired from the electronic commerce platform, and by adding to the text data an instruction statement that defines an output format, output items, and constraint conditions.

### (Supplementary 3)

The system according to supplementary 1,
wherein the processor is configured to
analyze, in the server, the cooking procedure data and the description data output from the generative AI model into a structured data format, generate interactive presentation data to which input interface elements corresponding to respective steps and notification timing information are added, and transmit the interactive presentation data to the portable information terminal so as to cause the portable information terminal to perform progress management of the steps and representation control of the steps in association with the operation input of the user.

### Application Example 1

### (Supplementary 1)

A system comprising a processor,
wherein the processor is configured to control an image acquisition unit to acquire an image of a storage apparatus and to store the image as digital data,
analyze the stored image data by using a machine learning model to identify items present in the storage apparatus, and specify at least a type, a quantity, and a storage state of each of the items, acquire a user input including at least one of voice input, text input, and selection input regarding a meal preference, and standardize a content of the user input into meal condition data by using natural language processing,
construct a prompt sentence including item information identified from the storage apparatus and the meal condition data, and input the prompt sentence into a generative AI model to cause the generative AI model to generate cooking procedure data,
analyze the cooking procedure data to extract information on required items, compare the information on required items with the item information identified from the storage apparatus, and specify insufficient items as missing items,
generate order data for the missing items, transmit the order data to an external delivery service via an external communication interface in accordance with an application programming interface of the external delivery service, and acquire delivery schedule information from the external delivery service,
analyze step information included in the cooking procedure data, construct an explanation prompt sentence for the generative AI model, and cause the generative AI model to generate explanation data for visual presentation or auditory presentation to a user based on the explanation prompt sentence,
acquire user state data including at least one of voice data, image data, and motion data of the user, and input the user state data into a machine learning model to estimate an emotional state of the user,
construct an adjustment prompt sentence based on at least the emotional state, the item information, the meal condition data, and the delivery schedule information, the adjustment prompt sentence being configured to adjust at least one of content of the cooking procedure, selection of items, difficulty of cooking, cooking time, and order content, and input the adjustment prompt sentence into the generative AI model to cause the generative AI model to generate adjustment result data, and
integrate the explanation data and the adjustment result data to generate integrated presentation information including recipe information, inventory status, order status of the missing items, and the delivery schedule information, and transmit the integrated presentation information to a user terminal for presentation to the user.

### (Supplementary 2)

The system according to supplementary 1,
wherein the processor is configured to control an imaging unit mounted on a portable user terminal as the image acquisition unit, and to receive image data acquired by the imaging unit from the portable user terminal via a communication network.

### (Supplementary 3)

The system according to supplementary 1,
wherein the processor is configured to execute image analysis including character recognition processing on the image of the storage apparatus to obtain display information of the items, and to record type information, expiration information, and quantity information of the items in a data storage device based on a result of the character recognition processing.

### Example 2

### (Supplementary 1)

A system comprising a processor,
wherein the processor is configured to
control an image acquisition apparatus of a portable terminal used by a user to acquire image data of an inside of a storage apparatus, and to cause the portable terminal to transmit the image data to a server via a communication path,
perform image preprocessing on the image data and perform inference processing using a machine learning model on a computing resource of the server so as to generate structured item information indicating at least a type, a quantity, and a validity period of an item stored in the storage apparatus,
acquire user input including at least one of voice input, text input, and selection input from the user, and convert the user input into standardized text data representing a meal preference of the user by using a natural language processing algorithm,
generate a prompt sentence including the item information and the standardized text data as input information, input the prompt sentence to a generative artificial intelligence model, and obtain, from the generative artificial intelligence model, cooking instruction data and cooking procedure data,
compare, by execution of comparison processing, required item information included in the cooking instruction data with the item information to specify a shortage item, generate merchandise information corresponding to the shortage item, transmit order data including the merchandise information to an electronic commerce platform through an application programming interface, calculate delivery time information based on a scheduled homecoming time of the user, and add the delivery time information to the order data,
generate, based on content of the cooking procedure data, a prompt sentence for generating explanation text for each cooking step for at least one of visual presentation and audio presentation, input the prompt sentence to the generative artificial intelligence model to obtain explanation text data, and cause the explanation text data to be presented stepwise to the user through a user interface,
acquire user state data including at least one of uttered voice of the user, facial image of the user, and body motion of the user, estimate an emotional state of the user by using a machine learning model based on the user state data, determine an adjustment parameter for changing at least one of cooking content, item selection, cooking difficulty, cooking time, and content of the order data based on the emotional state, the item information, and the cooking instruction data, generate a prompt sentence including the adjustment parameter, input the prompt sentence to the generative artificial intelligence model, and update at least one of the cooking instruction data, the cooking procedure data, and the order data based on a result generated by the generative artificial intelligence model, and
generate guidance data including the updated cooking procedure data and the delivery time information, and cause the guidance data to be transmitted to the portable terminal so that interactive cooking assistance presentation is performed on the portable terminal.

### (Supplementary 2)

The system according to supplementary 1,
wherein the processor is configured to
analyze the cooking procedure data obtained from the server, generate a screen configuration for sequentially displaying each cooking step on the portable terminal, update current step information in response to an operation input from the user, and execute display control processing for guiding a progress of cooking by activating at least one of timer processing and notification processing.

### (Supplementary 3)

The system according to supplementary 1,
wherein the processor is configured to
input the cooking instruction data obtained from the generative artificial intelligence model, as part of a prompt sentence, again to the generative artificial intelligence model, and execute a reformatting process for reconstructing the cooking procedure data so as to include a predetermined output format, a number of steps, time information, and temperature information.

### Application Example 2

### (Supplementary 1)

A system comprising a processor,
wherein the processor is configured to
control an image acquisition unit of a portable information processing apparatus of a user to acquire an image of a storage apparatus and to store the acquired image as digital data, analyze the acquired image data by applying an image processing algorithm and a machine learning model to identify food items in the storage apparatus, specify attribute information of the food items including at least a name, a quantity, and deadline information, and store the attribute information as structured data,
acquire a meal preference of the user based on voice input, character input, or selection input from the user, convert the meal preference into standardized meal preference data by using a natural language processing algorithm, and store the standardized meal preference data,
generate a prompt sentence for instructing a generative information processing model to generate a cooking procedure by using the identified attribute information of the food items and the standardized meal preference data as input, provide input data including the prompt sentence to the generative information processing model, and obtain cooking procedure data from the generative information processing model based on the prompt sentence,
analyze the cooking procedure data, compare required ingredient information included in the cooking procedure data with the attribute information of the food items in the storage apparatus to specify lacking ingredients, cooperate with a communication function to communicate with a communication interface of an electronic transaction service, and generate and transmit order request data including order information and delivery time information for the lacking ingredients to order the lacking ingredients and set a delivery time,
generate a prompt sentence for instructing the generative information processing model to generate explanatory text of the cooking procedure for each process included in the cooking procedure data, provide the prompt sentence to the generative information processing model to generate explanatory text data for visual presentation or audio presentation, and transmit the explanatory text data to the portable information processing apparatus,
acquire voice tone data, expression data, or body motion data of the user, apply an emotion estimation machine learning model to the data to estimate emotion information representing an emotional state of the user, and store the emotion information,
determine adjustment conditions for changing at least one of content of the cooking procedure, selection of ingredients, difficulty of cooking, cooking time, or content of ingredient ordering by using the emotion information and the cooking procedure data, generate a prompt sentence for instructing the generative information processing model to perform adjustment of the cooking procedure and ingredient information based on the emotion information, provide the prompt sentence to the generative information processing model, and obtain adjusted cooking procedure data and adjusted ingredient information from the generative information processing model, and generate presentation information by changing at least one of a level of detail, a number of processes, or an expression format of at least one of the adjusted cooking procedure data and the explanatory text data according to the emotional state of the user, and transmit the presentation information to the portable information processing apparatus.

### (Supplementary 2)

The system according to supplementary 1,
wherein the processor is configured to control the image acquisition unit and a sound acquisition unit mounted in the portable information processing apparatus to acquire the image data through the image acquisition unit and to acquire audio data through the sound acquisition unit, transmit the image data and the audio data to an information processing apparatus implementing the generative information processing model and the emotion estimation machine learning model, and present the explanatory text data and the presentation information received from the information processing apparatus to the user by using a display unit or a sound output unit.

### (Supplementary 3)

The system according to supplementary 1,
wherein the processor is configured to execute an image analysis process using a character information recognition algorithm on the image data including display information inside the storage apparatus to acquire label information of the food items, record, in a database, the name, the deadline information, and the quantity information of the food items as the attribute information based on the label information, and use the attribute information in generation of the prompt sentence provided to the generative information processing model.

What is claimed is:

1. A system comprising:
circuitry configured to:
receive, via a communication interface coupled to a packet-switched network, image data from a terminal device, and apply an image processing algorithm to convert the image data into a normalized tensor representation;
execute forward propagation of the normalized tensor representation through a convolutional neural network to compute feature maps and classification probability scores, apply confidence thresholding and non-maximum suppression to the classification probability scores to generate structured item records comprising a category identifier, a quantity estimate, and a validity period for each detected item;
receive, via the communication interface, user input data, and apply a natural language processing algorithm comprising tokenization and entity extraction to convert the user input data into standardized preference data stored in a storage device;
construct a structured prompt sentence by encoding the structured item records and the standardized preference data according to a predefined template, tokenize the structured prompt sentence using a subword tokenizer, and supply the tokenized prompt sentence to a generative neural network model to obtain procedure data comprising required item information and a sequence of operational steps;
compare the required item information with the structured item records to identify shortage items, generate order request data specifying the shortage items and a delivery time window, and transmit the order request data via the communication interface to an external transaction service;
receive multimodal behavior data comprising at least one of audio signals, image signals, and motion signals via the communication interface, extract feature vectors from the multimodal behavior data, and apply a trained classification network to the feature vectors to estimate an affective state value; and
construct an adjustment prompt sentence encoding the affective state value, the structured item records, and the standardized preference data, supply the adjustment prompt sentence to the generative neural network model, and update at least one of the procedure data and the order request data based on output received from the generative neural network model.

2. The system according to claim 1, wherein the circuitry is configured to apply an optical character recognition algorithm to label regions identified within the image data to extract textual attribute data, and merge the textual attribute data with the structured item records to update at least one of the category identifier and the validity period.

3. The system according to claim 2, wherein the circuitry is configured to compare the validity period of each structured item record against a threshold value, generate an expiration alert data structure identifying items having a validity period below the threshold value, and incorporate the expiration alert data structure into the structured prompt sentence supplied to the generative neural network model.

4. The system according to claim 3, wherein the image data comprises an image of a refrigerator interior, the category identifier represents a food ingredient category, and the validity period represents an expiration date of a corresponding food item.

5. The system according to claim 4, wherein the circuitry is configured to receive, as the user input data, at least one of a voice utterance, a text string, and a selection event representing a meal preference, and wherein the standardized preference data specifies at least one of a cuisine type, a serving count, a cooking time constraint, and a dietary restriction.

6. The system according to claim 1, wherein the circuitry is configured to construct the structured prompt sentence by arranging the structured item records as a labeled ingredient availability section, the standardized preference data as a labeled preference section, and output format instructions as a labeled constraint section, and to parse the procedure data received from the generative neural network model by locating the labeled sections in the output to extract the required item information and the sequence of operational steps as structured data objects.

7. The system according to claim 6, wherein the circuitry is configured to store the structured data objects in the storage device as a recipe record comprising one or more step records, each step record comprising a step index, a step description, and an estimated duration, and to update the recipe record based on the output received from the generative neural network model in response to the adjustment prompt sentence.

8. The system according to claim 7, wherein the circuitry is configured to construct, for each step record, a presentation prompt sentence comprising the step description and formatting instructions, supply each presentation prompt sentence to the generative neural network model to obtain presentation description data, and transmit the presentation description data to the terminal device via the communication interface for stepwise display.

9. The system according to claim 8, wherein the circuitry is configured to receive progress status data from the terminal device via the communication interface indicating a current step index, update a session record in the storage device based on the progress status data, and align the delivery time window of the order request data with the current step index.

10. The system according to claim 1, wherein the circuitry is configured to map each shortage item to a product identifier in a product catalog stored in the storage device, and to generate the order request data comprising the product identifier, a quantity value, a delivery destination address, and the delivery time window computed based on a scheduled return time parameter associated with the terminal device.

11. The system according to claim 10, wherein the circuitry is configured to receive delivery schedule confirmation data from the external transaction service via the communication interface, store an order identifier and a confirmed delivery time window in the storage device, and incorporate the confirmed delivery time window into the procedure data transmitted to the terminal device.

12. The system according to claim 1, wherein the circuitry is configured to extract, from the audio signals of the multimodal behavior data, acoustic feature vectors comprising pitch contour values, energy envelope values, and spectral coefficient values, and to extract, from the image signals of the multimodal behavior data, facial expression feature vectors using a convolutional feature extraction network, and to concatenate the acoustic feature vectors and the facial expression feature vectors prior to applying the trained classification network.

13. The system according to claim 12, wherein the trained classification network outputs a probability distribution over a plurality of affective state labels, and wherein the circuitry is configured to select an affective state label having a highest probability as the affective state value, and to determine adjustment conditions comprising at least one of a target step count, a maximum total duration, and a complexity level based on the affective state label.

14. The system according to claim 13, wherein the circuitry is configured to construct the adjustment prompt sentence by encoding the adjustment conditions and a summary of the sequence of operational steps, supply the adjustment prompt sentence to the generative neural network model to obtain adjusted operational steps and adjusted required item information, and update the recipe record and the order request data based on the adjusted operational steps and the adjusted required item information.

15. The system according to claim 14, wherein when the affective state label indicates a high-stress state, the circuitry is configured to set the target step count below a predefined threshold and the maximum total duration below a predefined time limit, and to transmit updated presentation description data to the terminal device reflecting the adjusted operational steps.

16. The system according to claim 1, wherein the circuitry is configured to retrieve past session records from the storage device, extract historical preference patterns from the past session records, and incorporate the historical preference patterns as an additional labeled section in the structured prompt sentence to condition the generative neural network model to weight outputs toward historically preferred operational sequences.

17. The system according to claim 16, wherein the circuitry is configured to generate integrated presentation data comprising the procedure data, an inventory status derived from the structured item records, an order status derived from the order request data, and the delivery time window, and to transmit the integrated presentation data to the terminal device for synchronized stepwise presentation.

18. A system comprising:
circuitry configured to:
receive, via a communication interface coupled to a packet-switched network, image data from a terminal device, apply an image processing algorithm to convert the image data into a normalized tensor representation, and execute forward propagation of the normalized tensor representation through a convolutional neural network to compute feature maps and classification probability scores;
apply confidence thresholding and non-maximum suppression to the classification probability scores to generate structured item records comprising a category identifier, a quantity estimate, and a validity period, and apply an optical character recognition algorithm to label regions in the image data to update the validity period in the structured item records;
receive user input data via the communication interface, apply a natural language processing algorithm comprising tokenization, part-of-speech tagging, and entity extraction to convert the user input data into standardized preference data specifying at least a content category, a serving count, and a preparation time constraint;
construct a structured prompt sentence encoding the structured item records and the standardized preference data, tokenize the structured prompt sentence using a subword tokenizer, supply the tokenized prompt sentence to a generative neural network model, and parse output from the generative neural network model to extract a procedure record comprising required item information and an ordered sequence of step records;
compare the required item information with the structured item records to identify shortage items, map each shortage item to a product identifier in a product catalog, generate order request data comprising the product identifier and a delivery time window, and transmit the order request data to an external transaction service via the communication interface;
extract acoustic feature vectors and facial expression feature vectors from multimodal behavior data received via the communication interface, concatenate the acoustic feature vectors and the facial expression feature vectors, and apply a trained classification network to the concatenated feature vectors to output a probability distribution over affective state labels; and
select an affective state label from the probability distribution, determine adjustment conditions based on the affective state label, construct an adjustment prompt sentence encoding the adjustment conditions and a summary of the step records, supply the adjustment prompt sentence to the generative neural network model to obtain adjusted step records and adjusted required item information, and update the procedure record and the order request data based on the adjusted step records.

19. The system according to claim 18, wherein the circuitry is configured to construct, for each step record in the adjusted procedure record, a presentation prompt sentence comprising a step description and formatting instructions, supply each presentation prompt sentence to the generative neural network model to obtain presentation description data, transmit the presentation description data to the terminal device for stepwise display, receive progress status data from the terminal device indicating a current step index, and align the delivery time window with the current step index.

20. A method comprising:
receiving, via a communication interface coupled to a packet-switched network, image data from a terminal device, and applying an image processing algorithm to convert the image data into a normalized tensor representation;
executing forward propagation of the normalized tensor representation through a convolutional neural network to compute feature maps and classification probability scores, and applying confidence thresholding and non-maximum suppression to the classification probability scores to generate structured item records comprising a category identifier, a quantity estimate, and a validity period for each detected item;
receiving user input data via the communication interface, and applying a natural language processing algorithm comprising tokenization and entity extraction to convert the user input data into standardized preference data stored in a storage device;
constructing a structured prompt sentence by encoding the structured item records and the standardized preference data according to a predefined template, tokenizing the structured prompt sentence using a subword tokenizer, and supplying the tokenized prompt sentence to a generative neural network model to obtain procedure data comprising required item information and a sequence of operational steps;
comparing the required item information with the structured item records to identify shortage items, generating order request data specifying the shortage items and a delivery time window, and transmitting the order request data via the communication interface to an external transaction service;
receiving multimodal behavior data comprising at least one of audio signals, image signals, and motion signals via the communication interface, extracting feature vectors from the multimodal behavior data, and applying a trained classification network to the feature vectors to estimate an affective state value; and
constructing an adjustment prompt sentence encoding the affective state value, the structured item records, and the standardized preference data, supplying the adjustment prompt sentence to the generative neural network model, and updating at least one of the procedure data and the order request data based on output received from the generative neural network model.
